(19) United States
(12) Patent Application Publication
(10) Pub. No.: US 2022/0051240 A1
(43) Pub. Date: Feb. 17, 2022

(54) TRANSFERRING CRYPTOCURRENCY FROM A REMOTE LIMITED ACCESS WALLET

(71) Applicant: GK8 LTD, Tel Aviv (IL)

(72) Inventors: Shahar SHAMAI, Rehovot (IL); Lior LAMESH, Rishon-LeZion (IL)

(73) Assignee: GK8 LTD, Tel Aviv (IL)

(21) Appl. No.: 16/989,939

(22) Filed: Aug. 11, 2020

(51) Int. Cl. G06Q 20/40; G06Q 20/06; G06Q 20/38; H04L 9/06

(52) U.S. Cl. CPC G06Q 20/401; G06Q 20/0655; G06Q 20/3825; G06Q 2220/00; G06Q 20/405; H04L 2209/38; H04L 2209/46; H04L 9/0637

(57) ABSTRACT

Provided herein are systems, devices and methods for transferring cryptocurrency from a limited access cryptocurrency wallet. The limited access cryptocurrency wallet may create, in advance, provisional account(s) allocated for respective recipient(s) and transfer a predefined overall value of cryptocurrency from its associated account associated to the provisional account(s). The limited access cryptocurrency wallet may further generate, in advance, a plurality of signed transactions for transferring a plurality of predefined partial values of cryptocurrency from the provisional account(s) to receiving account(s) associated with the recipient(s) and transmit the plurality of signed transactions to a network connected cryptocurrency wallet. Later, in real-time, the network connected cryptocurrency wallet may transmit one or more of the plurality of signed transactions for transferring cryptocurrency from the provisional account(s) to the receiving account(s) without physically attending to the limited access cryptocurrency wallet.

### FIELD AND BACKGROUND OF THE INVENTION

The present invention, in some embodiments thereof, relates to transferring cryptocurrency funds from a cryptocurrency wallet, and, more specifically, but not exclusively, to transferring cryptocurrency funds from a limited access cryptocurrency wallet without physically attending to the limited access cryptocurrency wallet.

In the modern era, financial transactions are mainly done using digitally based transaction instructions for transferring fiat (real) money thus replacing the traditional actual money transactions.

In recent years the introduction of blockchain based cryptocurrencies has paved the way for further usage of digital currency, specifically cryptocurrencies which are in fact virtual currency that are not regulated by any one single entity, such as states, central banks and/or the like.

While presenting many advantages, using the cryptocurrencies may present major security concerns since such cryptocurrencies are regulated by vast computer networks which are inherently prone to malicious attacks. Trading using the cryptocurrency essentially requires network connection which further exposes the digital wallets, which are electronic devices storing the user accounts, to such malicious attacks launched by malicious parties in attempt to gain control over the cryptocurrency stored in these accounts.

### SUMMARY OF THE INVENTION

According to a first aspect of the present invention there is provided a method of transferring cryptocurrency from a limited access cryptocurrency wallet, comprising using one or more processors of a limited access cryptocurrency wallet having transmit-only network connectivity. The one or more processors are used for:
Creating one or more provisional accounts allocated for respective one or more recipients.
Transmitting one or more transactions to transfer a predefined overall value of cryptocurrency from an account associated with the limited access cryptocurrency wallet to the one or more provisional accounts. The one or more transactions are recorded in a blockchain maintained by a plurality of networked computing nodes.
Generating a plurality of signed transactions for transferring a plurality of predefined partial values of cryptocurrency from the one or more provisional accounts to one or more receiving accounts associated with the respective one or more recipients. A sum of the plurality of predefined partial values does not exceed the predefined overall value.
Transmitting the plurality of signed transactions to a network connected cryptocurrency wallet configured to transmit one or more of the plurality of signed transactions for transferring cryptocurrency from the one or more provisional accounts to the respective one or more receiving accounts without physically attending to the limited access cryptocurrency wallet.

According to a second aspect of the present invention there is provided a limited access cryptocurrency wallet device, comprising a non-transitory storage medium storing a code and one or more processors coupled to the non-transitory storage medium. The one or more processors execute the code. The code comprising:
Code instructions to create one or more provisional accounts allocated for respective one or more recipients.
Code instructions to transmit one or more transactions to transfer a predefined overall value of cryptocurrency from an account associated with the limited access cryptocurrency wallet to the one or more provisional accounts. The one or more transactions are recorded in a blockchain maintained by a plurality of networked computing nodes.
Code instructions to generate a plurality of signed transactions for transferring a plurality of predefined partial values of cryptocurrency from the one or more provisional accounts to one or more receiving accounts associated with the respective one or more recipients. A sum of the plurality of predefined partial values does not exceed the predefined overall value.
Code instructions to transmit the plurality of signed transactions to a network connected cryptocurrency wallet configured to transmit one or more of the plurality of signed transactions for transferring cryptocurrency from the one or more provisional accounts to the respective one or more receiving accounts without physically attending to the limited access cryptocurrency wallet.

In an optional implementation form of the first and/or second aspects, the limited access cryptocurrency wallet is utilized by a plurality of computing nodes using one or more Multi-Party Computation (MPC) protocols to generate the plurality of signed transactions.

In a further implementation form of the first and/or second aspects, the plurality of predefined partial values are simultaneously valid.

In a further implementation form of the first and/or second aspects, the network connected cryptocurrency wallet is implemented by a subset of the plurality of networked computing nodes using one or more Multi-Party Computation (MPC) protocols to transmit one or more of the signed transactions to the one or more receiving accounts.

In an optional implementation form of the first and/or second aspects, the one or more processors are further configured to generate a plurality of signed excess transactions for transferring cryptocurrency from one or more of the provisional accounts to an account associated with the limited access cryptocurrency wallet. The network connected cryptocurrency wallet is configured to transmit one or more of the plurality of signed excess transactions to the account associated with the limited access cryptocurrency wallet in case of an excess in a transaction transmitted to the receiving account.

In an optional implementation form of the first and/or second aspects, the one or more processors are further configured for:
Creating a plurality of provisional account each allocated to a respective one of a plurality of recipients.
Transmitting one or more transactions to transfer a predefined value of cryptocurrency from the account associated with the limited access cryptocurrency wallet to each of the plurality of provisional accounts.
Generating a plurality of signed transactions of a plurality of predefined partial values of cryptocurrency from one or more of the plurality of provisional accounts to another one or more of the plurality of provisional accounts.

In a further implementation form of the first and/or second aspects, one or more of the provisional accounts are created by the limited access cryptocurrency wallet as a payment channel 2-2 multisig account in which each transaction from the one or more provisional accounts to the one or more receiving accounts which is recorded in the blockchain is further signed by the respective one or more recipients. The plurality of signed transactions are defined for transferring predefined gradually increasing partial values of the predefined overall value.

In a further implementation form of the first and/or second aspects, the network connected cryptocurrency wallet transmits a plurality of the signed transactions for transferring cryptocurrency from the one or more provisional accounts to the one or more receiving accounts which are not signed by the respective one or more recipients and are thus not recorded in the blockchain, each of the plurality of signed transactions replaces a preceding signed transaction transmitted to the one or more receiving accounts by using a transaction identifier (ID) of the transmitted preceding signed transaction. Each transmitted signed transaction includes a value of cryptocurrency which is a sum of cryptocurrency transferred in the preceding signed transaction and a value of cryptocurrency transferred in the respective signed transaction.

In a further implementation form of the first and/or second aspects, a most recent signed transaction transmitted by the network connected cryptocurrency wallet for transferring cryptocurrency from the one or more provisional accounts to the one or more receiving accounts is recorded in the blockchain in case the respective one or more recipient signs the most recent transmitted signed transaction.

In an optional implementation form of the first and/or second aspects, the payment channel 2-2 multisig account is a time limited account associated with an expiration time. In case the respective one or more recipients fail to sign the most recent signed transaction transmitted for transferring cryptocurrency from the one or more provisional accounts to the one or more receiving accounts within the expiration time the value of cryptocurrency stored in the payment channel 2-2 multisig account is transmitted back to the account associated with the limited access cryptocurrency wallet.

In an optional implementation form of the first and/or second aspects, in case the one or more receiving accounts is associated with a respective cryptocurrency wallet of the respective one or more recipients which is not configured to support the payment channel 2-2 multisig account, the payment channel 2-2 multisig account is configured such that each signed transaction transmitted for transferring cryptocurrency from the one or more provisional accounts to the one or more receiving accounts which is recorded in the blockchain requires a signature of another network connected device associated with the respective one or more recipients.

In an optional implementation form of the first and/or second aspects, the limited access cryptocurrency wallet closes the one or more provisional accounts by transmitting an instruction to the network connected cryptocurrency wallet to close the payment channel 2-2 multisig account jointly with the respective one or more recipients.

In a further implementation form of the first and/or second aspects, the one or more provisional accounts are created by the limited access cryptocurrency wallet as new cryptocurrency accounts associated with the limited access cryptocurrency wallet.

In a further implementation form of the first and/or second aspects, in case the cryptocurrency is an account based cryptocurrency in which each transaction includes a nonce indicative of a number of previous transactions, the limited access cryptocurrency wallet generates the plurality of signed transactions to constitute a flat distribution of the predefined overall value according to a predefined granularity such that each of the plurality of signed transactions includes a respective one of a plurality of valid nonces and a respective predefined partial value.

In a further implementation form of the first and/or second aspects, when transferring a certain value of cryptocurrency to the one or more receiving accounts, the network connected cryptocurrency wallet selects one or more of the plurality of signed transaction having a predefined partial value which is equal or exceeding the certain value. All other signed transaction having the same nonce and other predefined partial value are discarded.

In an optional implementation form of the first and/or second aspects, the one or more processors are further configured for generating the plurality of signed transactions for transferring each of the predefined partial values to one of a plurality of receiving accounts by configuring the plurality of signed transactions to constitute a predefined overall value such that each of the plurality of signed transactions includes a respective one of a plurality of valid nonces. The respective predefined partial value of the predefined overall value and a respective target receiving account of the plurality of receiving accounts.

In an optional implementation form of the first and/or second aspects, the one or more processors are further configured for defining the account associated with the limited access cryptocurrency wallet as one of the plurality of receiving accounts such that the network connected cryptocurrency wallet transmits one or more of the plurality of signed transactions to transfer cryptocurrency to its associated account.

In an optional implementation form of the first and/or second aspects, the limited access cryptocurrency wallet closes the one or more provisional accounts by transmitting an instruction to the network connected cryptocurrency wallet to close the account based provisional account.

In an optional implementation form of the first and/or second aspects, the limited access cryptocurrency wallet closes the one or more provisional accounts by transmitting one or more transactions to transfer cryptocurrency to its associated account which are recorded in the blockchain and includes the nonce of one or more of the plurality of signed transactions and a cryptocurrency value of zero.

In a further implementation form of the first and/or second aspects, in case the cryptocurrency is a transaction based cryptocurrency (UTXO) in which each transaction includes one or more input values of cryptocurrency which is traced to a respective output value of a previous transaction. The limited access cryptocurrency wallet generates the plurality of signed transactions to constitute a hierarchical Directed Acyclic Graph (DAG) comprising the plurality of signed transaction such that each signed transaction is derived from a higher layer signed transaction and includes a Transaction ID (TXID). The hierarchical DAG is constructed to distribute the predefined overall value according to a predefined granularity.

In a further implementation form of the first and/or second aspects, the DAG is constructed as a hierarchical tree.

In a further implementation form of the first and/or second aspects, when transferring a certain value of cryptocurrency to the one or more receiving accounts, the network connected cryptocurrency wallet selects at least a segment of the hierarchical DAG comprising one or more signed transactions having a predefined partial value which is equal or exceeding the certain value. Each signed transaction of the segment which is not transmitted is marked as unusable.

In an optional implementation form of the first and/or second aspects, the limited access cryptocurrency wallet is informed of a remaining value of cryptocurrency available in one or more unusable transactions by inserting one or more limited length strings to the limited access cryptocurrency wallet via a limited capacity input interface of the limited access cryptocurrency wallet configured to receive one or more limited length strings.

In an optional implementation form of the first and/or second aspects, the one or more strings include an index of the one or more unusable transactions such that limited access cryptocurrency wallet derives the remaining value from the index which is known to the limited access cryptocurrency wallet which initially generated the plurality of signed transactions including the of one or more unusable transactions.

In an optional implementation form of the first and/or second aspects, the limited access cryptocurrency wallet transmits a transaction to its associated account which is recorded in the blockchain and comprises the cumulative sum of cryptocurrency partial values included in the one or more unusable signed transactions.

In an optional implementation form of the first and/or second aspects, in case the respective one or more recipients uses other limited access cryptocurrency wallet, the other limited access cryptocurrency wallet is informed of the value of cryptocurrency transferred to its associated receiving account by inserting one or more limited length strings to the other limited access cryptocurrency wallet via a limited capacity input interface of the other limited access cryptocurrency wallet. The one or more strings comprising a description of a first signed transaction of the plurality of signed transactions transmitted to the receiving account of the other limited access cryptocurrency wallet, a structure of the hierarchical DAG and an index of a final signed transaction of the plurality of signed transactions transmitted to transfer cryptocurrency to the receiving account of the other limited access cryptocurrency wallet.

In an optional implementation form of the first and/or second aspects, in case a commission needs to be allocated to one or more of the plurality of computing nodes for recording the one or more signed transactions in the blockchain. The limited access cryptocurrency wallet extends each of the plurality of signed transactions to a set of respective signed transactions each allocating a respective value of cryptocurrency for the commission. The network connected cryptocurrency wallet selects one of the transactions of the set according to the commission value.

In an optional implementation form of the first and/or second aspects, in case a commission needs to be allocated to one or more of the plurality of computing nodes for recording the one or more signed transactions in the blockchain. The limited access cryptocurrency wallet generates one or more commission allocation transactions comprising a cryptocurrency value dedicated for commission fees and transmits the one or more commission allocation transactions to transfer cryptocurrency to an account associated with the network connected cryptocurrency wallet, the network connected cryptocurrency wallet transmits one or more commission allocation transaction to transfer cryptocurrency to the one or more computing nodes which recorded the one or more signed transactions. The one or more commission allocation transactions comprising a value of cryptocurrency sufficient for commission for both the one or more signed transactions and for the one or more commission allocation transactions.

In an optional implementation form of the first and/or second aspects, in case a commission needs to be allocated to one or more of the plurality of computing nodes for recording the one or more signed transactions in the blockchain. The limited access cryptocurrency wallet establishes an agreement with at least partner computing node of the plurality of computing nodes stating that the at least partner computing node records each of the plurality of signed transactions transmitted by the network connected cryptocurrency wallet to transfer cryptocurrency from the one or more provisional accounts to the one or more receiving accounts.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 presents flowcharts of exemplary processes executed by a limited access cryptocurrency wallet and a network connected cryptocurrency wallet for transferring cryptocurrency funds from an account associated with the limited access cryptocurrency wallet to one or more other accounts without physically attending to the limited access cryptocurrency wallet device, according to some embodiments of the present invention;

FIG. 2 is a schematic illustration of an exemplary system for transferring cryptocurrency funds from an account associated with a limited access cryptocurrency wallet to one or more other accounts without physically attending to the limited access cryptocurrency wallet device, according to some embodiments of the present invention;

FIG. 3 is a schematic illustration of an exemplary sequence of transferring cryptocurrency funds from an account associated with a limited access cryptocurrency wallet to one or more other accounts without physically attending to the limited access cryptocurrency wallet device, according to some embodiments of the present invention;

FIG. 4 is a schematic illustration of an exemplary construction of a plurality of signed cryptocurrency transactions generated in advance for a payment channel provisional account, according to some embodiments of the present invention;

FIG. 5 is a schematic illustration of an exemplary construction of a plurality of signed cryptocurrency transactions generated in advance according to a predefined flat distribution for an account based cryptocurrency service, according to some embodiments of the present invention;

FIG. 6 is a schematic illustration of an exemplary construction of a plurality of provisional accounts in a layered structure for an account based cryptocurrency service, according to some embodiments of the present invention;

FIG. 7A and FIG. 7B are schematic illustrations of an exemplary hierarchical tree construction of a plurality of signed cryptocurrency transactions generated in advance according to a predefined tree distribution for a transaction based cryptocurrency service, according to some embodiments of the present invention; and

FIG. 8A and FIG. 8B are schematic illustrations of exemplary utilizations of an exemplary hierarchical tree construction for transferring cryptocurrency funds to a receiving account, according to some embodiments of the present invention.

### DESCRIPTION OF SPECIFIC EMBODIMENTS OF THE INVENTION

The present invention, in some embodiments thereof, relates to transferring cryptocurrency funds from a cryptocurrency wallet, and, more specifically, but not exclusively, to transferring cryptocurrency funds from a limited access cryptocurrency wallet without physically attending to the limited access cryptocurrency wallet.

According to some embodiments of the present invention, there are provided methods, systems and computer program products for transferring cryptocurrency funds from an account associated with a limited access cryptocurrency wallet to one or more other accounts without physically attending to the limited access cryptocurrency wallet device. The limited access cryptocurrency wallet device which may be, for example, a cold wallet incapable of receiving data from the network, an offline hot wallet, a group of offline computing nodes and/or the like may be stored for security reasons in a secure location, for example, a safe, a restricted access location and/or the like and may be thus inaccessible. The cryptocurrency platform or service, for example, Bitcoin, Bitcoin cash, Ethereum, Ripple and/or the like is blockchain based platform regulated by a plurality of computing nodes independent of each other which maintain a distributed ledger according to one or more protocols defined by the cryptocurrency platform.

The limited access cryptocurrency wallet may be operated to create, in advance, provisions and means for transferring cryptocurrency funds to one or more receiving account associated with one or more specific recipients to whom the owner (user) of the limited access cryptocurrency wallet may wish to transfer cryptocurrency in the future. The limited access cryptocurrency wallet, specifically the cold wallet may be an isolated device comprising a transmit-only communication interface, for example, a unidirectional transmitter to facilitate a unidirectional (one-way) transmit only communication channel with one or more other network connected resources. In another example, even if the limited access cryptocurrency wallet is a hot wallet capable of receiving network data, while stored in the secure location, the hot wallet is disconnected from the network. As such the limited access cryptocurrency wallet may be unable to receive data from the network and may be thus highly immune to network based malicious attacks.

The limited access cryptocurrency wallet may be operated to create provisions for transferring a large value (amount) of cryptocurrency in a plurality of transactions each comprising a predefined partial cryptocurrency value over a time period during which the limited access cryptocurrency wallet may be securely stored and inaccessible.

Specifically, the limited access cryptocurrency wallet may be configured and operated to create one or more provisional accounts each allocated for a respective one of the recipient(s) to whom the associated user may wish to transfer cryptocurrency funds in the future. By its nature, the provisional account is a temporary account intended for a specific use and is thus allocated for a specific recipient for a limited time period. After created, the limited access cryptocurrency wallet may transmit one or more transactions to transfer a predefined overall value of cryptocurrency, typically a substantial value of cryptocurrency, from an account associated with the limited access cryptocurrency wallet to each provisional account.

The limited access cryptocurrency wallet may then generate a plurality of transactions of cryptocurrency from each provisional account to a respective receiving account associated with a respective one of the recipient(s). Each of the plurality of signed transactions generated by the limited access cryptocurrency wallet may be configured for transferring a predefined partial value of the overall value of cryptocurrency initially transferred to the provisional account such that a sum of the plurality of predefined partial values does not exceed the predefined overall value. Each signed transaction therefore includes at least an account identifier (ID) of the respective provisional account, an account ID of the respective receiving account, a partial value of cryptocurrency and a signature of the limited access cryptocurrency wallet device. One or more of the signed transactions may further include one or more additional data items, fields, flags and/or the like as defined by the cryptocurrency in use. The limited access cryptocurrency wallet may sign each signed transaction using its unique private key, for example, compute a hash value for each transaction using one or more hash functions as known in the art. The signed transactions are thus valid transactions of cryptocurrency from the provisional account to the respective receiving account and may not be generated and/or replicated by any other party since the private key is only available to the limited access cryptocurrency wallet.

The limited access cryptocurrency wallet may then transmit the plurality of signed transactions to a network connected cryptocurrency wallet, for example, a hot wallet connected to the network which is associated with the user. The network connected cryptocurrency wallet may be utilized by a single device connected to the network or by a group of multiple commuting nodes which may engage in one or more Multi-Party Computation (MPC) sessions to jointly operate as the network connected cryptocurrency wallet. The signed transactions are not recorded in the blockchain but are rather only stored by the network connected cryptocurrency wallet.

From this point on the limited access cryptocurrency wallet is no longer needed and may be stored in secure location, for example, a safe, a restricted access location and/or the like to ensure security of the cryptocurrency funds stored by the limited access cryptocurrency wallet. Since it is remotely stored, the limited access cryptocurrency wallet be physically inaccessible and thus cannot be physically operated and/or attended by its associated user (owner).

However, the cryptocurrency funds transferred in advance from the account associated with the limited access cryptocurrency wallet to one or more of the provisional accounts and/or part thereof may still be transferred to the respective receiving account(s) associated with a respective one of the designated recipient(s). This may be done by instructing, configuring and/or otherwise operating the network connected cryptocurrency wallet, in real-time, to transmit one or more of the signed transaction generated in advance by the limited access cryptocurrency wallet. In particular, the network connected cryptocurrency wallet may select, in response to an instruction to transfer a certain value of cryptocurrency to a certain receiving account, one or more of the signed transactions which comprise partial values that are cumulatively equal or greater than the certain cryptocurrency value that needs to be transferred.

This means that the network connected cryptocurrency wallet may be operated to transfer cryptocurrency funds (not exceeding the overall value transferred to each provisional account) originally transferred from the account associated with the limited access cryptocurrency wallet without physically attending to the limited access cryptocurrency wallet which may remain in the secure storage location.

As described herein after in details, according to various embodiments of the present invention, the provisional accounts and the signed transactions may be created, generated, configured and/or adjusted to support practically any type of cryptocurrency system or service including account based cryptocurrencies such as, for example, Ethereum, Ripple and/or the like as well as transaction based (UTXO) cryptocurrencies such as, for example, Bitcoin, Bitcoin cash and/or the like.

Moreover, in the preliminary phase, the limited access cryptocurrency wallet may be operated to create a plurality of signed excess transactions for transferring at least some of the partial values back to the account associated with the limited access cryptocurrency wallet.

Transferring cryptocurrency funds from the account associated with the limited access cryptocurrency wallet which may be remote and securely stored without physically attending to the limited access cryptocurrency wallet may present major benefits and advantages.

First, a predefined certain value of the cryptocurrency funds stored in the limited access cryptocurrency wallet may be available for transfer without attending to the limited access cryptocurrency wallet while the reminder of the cryptocurrency funds stored in the limited access cryptocurrency wallet is highly secured by storing the limited access cryptocurrency wallet in the secure location.

Moreover, since the overall value of cryptocurrency funds transferred to each provisional account may be restricted and/or limited, the risk for losing the cryptocurrency funds stored in the provisional account(s) is limited to the restricted overall value transferred to each of the provisional account(s). In addition, since the signed transactions are signed in advance for transferring cryptocurrency funds from the provisional account(s) only to the receiving account(s) associated with the specific recipient(s), these cryptocurrency funds may not be fraudulently used for other purposes.

Furthermore, since the signed transactions are signed in advance for transferring cryptocurrency funds from the provisional account(s) only to the receiving account(s) associated with the specific recipient(s), these signed transactions cannot be altered by a potential malicious party in attempt to direct the cryptocurrency funds stored in the provisional account(s) to other account(s). At worst, the malicious party may cause transmission of one or more of the signed transactions to one or more of the receiving account(s). However, since these receiving account(s) are associated with specific recipients which are typically long term trade partners and thus may be trustworthy, the transferred funds may not be lost.

In addition, the methods, systems and devices presented herein may be adapted to support a wide range of cryptocurrencies. Transferring cryptocurrency funds from the account associated with the limited access cryptocurrency wallet without physically attending it, may be therefore easily applied and adopted by most if not all popular and common cryptocurrencies.

Also, cryptocurrency funds may be transmitted automatically from one or more of the provisional accounts with no human intervention. Specifically, the network connected cryptocurrency wallet may automatically transmit one or more of the signed transactions in response to one or more trigger events, for example, a predefined scheduled time, an action conducted by one or more of the recipients, a transaction and/or other event detected in the blockchain network and/or the like.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer Program code comprising computer readable program instructions embodied on a computer readable medium may be transmitted using any appropriate medium, including but not limited to wireless, wire line, optical fiber cable, RF, etc., or any suitable combination of the foregoing.

The program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code can be downloaded to respective computing/processing devices from a computer readable storage medium or to an external computer or external storage device via a network, for example, the Internet, a local area network, a wide area network and/or a wireless network.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

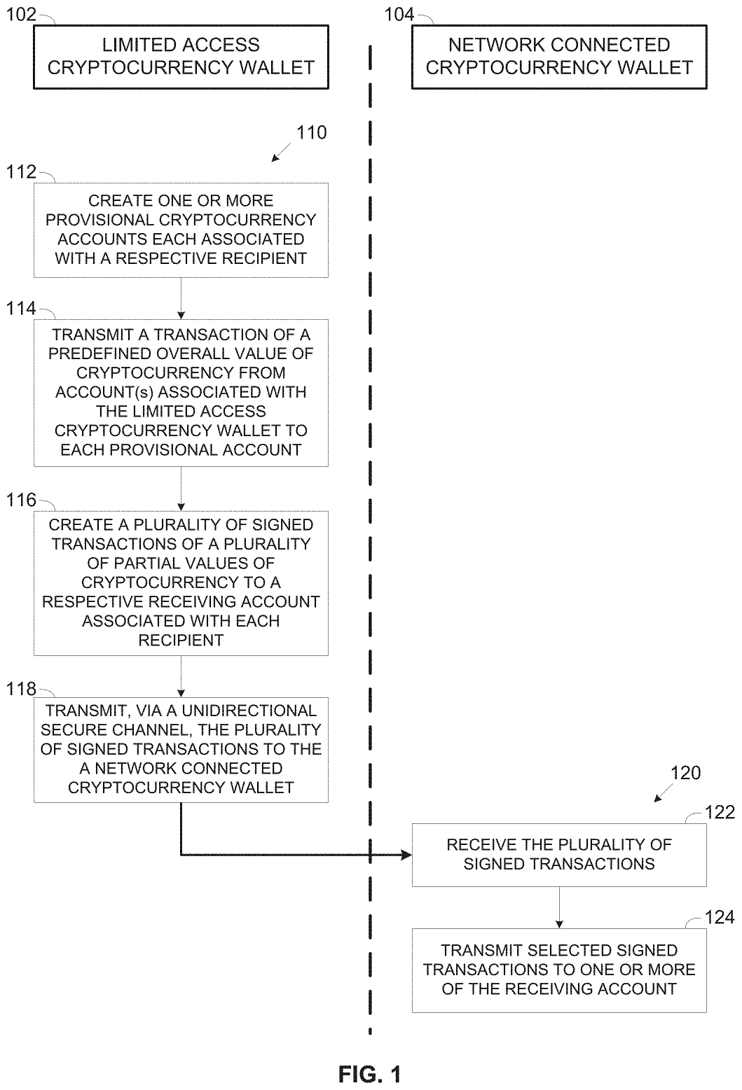

Referring now to the drawings, FIG. 1 illustrates flowcharts of exemplary processes executed by a limited access cryptocurrency wallet and a network connected cryptocurrency wallet for transferring cryptocurrency funds from an account associated with the limited access cryptocurrency wallet to one or more other accounts without physically attending to the limited access cryptocurrency wallet device, according to some embodiments of the present invention.

An exemplary process 110 may be executed by a limited access cryptocurrency wallet 102 which is a device used as a digital wallet for a cryptocurrency, for example, Bitcoin, Bitcoin cash, Ethereum, Ripple and/or the like controlled by a network of computing nodes regulating the cryptocurrency, for example, a blockchain network maintaining a blockchain.

In particular, the limited access cryptocurrency wallet 102 may be typically disconnected from the network may allow limited access, for example, stored in a secure location (e.g. safe) where it is not physically accessible and hence not physically operable by an associated user. While the limited access cryptocurrency wallet 102 is not accessible and may not be physically operable, it may be highly desired to transfer cryptocurrency funds from one or more cryptocurrency accounts associated with the limited access cryptocurrency wallet 102 to one or more other accounts of one or more recipients, designated receiving accounts herein after without physically attending (accessing) to the limited access cryptocurrency wallet 102.

To this end the limited access cryptocurrency wallet 102 may execute the process 110 for creating, in advance, means and provisions to enable transfer of cryptocurrency to one or more of the receiving accounts.

The limited access cryptocurrency wallet 102 may be configured to create one or more provisional accounts each allocated for a respective recipient to whom the associated user may wish to transfer cryptocurrency funds in the future. The limited access cryptocurrency wallet 102 may transfer a predefined value of cryptocurrency, typically a substantial value of cryptocurrency to one or more of the provisional accounts. The value of cryptocurrency transferred to each provisional account is designated the overall value.

The limited access cryptocurrency wallet 102 may then generate a plurality of transactions of cryptocurrency from each provisional account to a respective receiving account. Each of the plurality of transactions is properly signed by the limited access cryptocurrency wallet 102 using its unique private key and is thus a valid transaction of cryptocurrency from the provisional account to each of one or more of the receiving accounts. The limited access cryptocurrency wallet 102 may generate each of the plurality of signed transactions for transferring a predefined partial value of the overall value of cryptocurrency initially transferred such that a sum of the plurality of predefined partial values does not exceed the predefined overall value.

The limited access cryptocurrency wallet 102 may then transmit the plurality of signed transactions to a network connected cryptocurrency wallet 104 which may be utilized by a single device connected to the network or by a group of multiple commuting nodes which may engage in one or more Multi-Party Computation (MPC) sessions to jointly operate as the network connected cryptocurrency wallet 104.

The network connected cryptocurrency wallet 104 executing exemplary process 120, may receive the plurality of signed transactions. The network connected cryptocurrency wallet 104 may further transfer one or more of the signed transactions to one or more of the receiving accounts. Specifically, the network connected cryptocurrency wallet 104 may be instructed by the user associated with the limited access cryptocurrency wallet 102 to transfer one or more cryptocurrency transactions to the receiving account. In response to the instructions, the network connected cryptocurrency wallet 104 may transmit one or more of the signed transaction created in advance by the limited access cryptocurrency wallet 102 for transferring cryptocurrency to the receiving account. Specifically, the network connected cryptocurrency wallet 104 may transmit signed transaction(s) selected according to its partial values such that the partial value(s) is equal or greater than the value instructed for transfer by the user.

As such, cryptocurrency which is stored in account(s) controlled by the limited access cryptocurrency wallet 102 may be transferred, later in real-time, to other accounts by operating the network connected cryptocurrency wallet 104 to transmit the signed transaction(s) which were created in advance without physically attending to the limited access cryptocurrency wallet 102. Moreover, using the singed transactions, cryptocurrency funds may be transferred only to the recipient(s) defined and designated by the limited access cryptocurrency wallet 102.

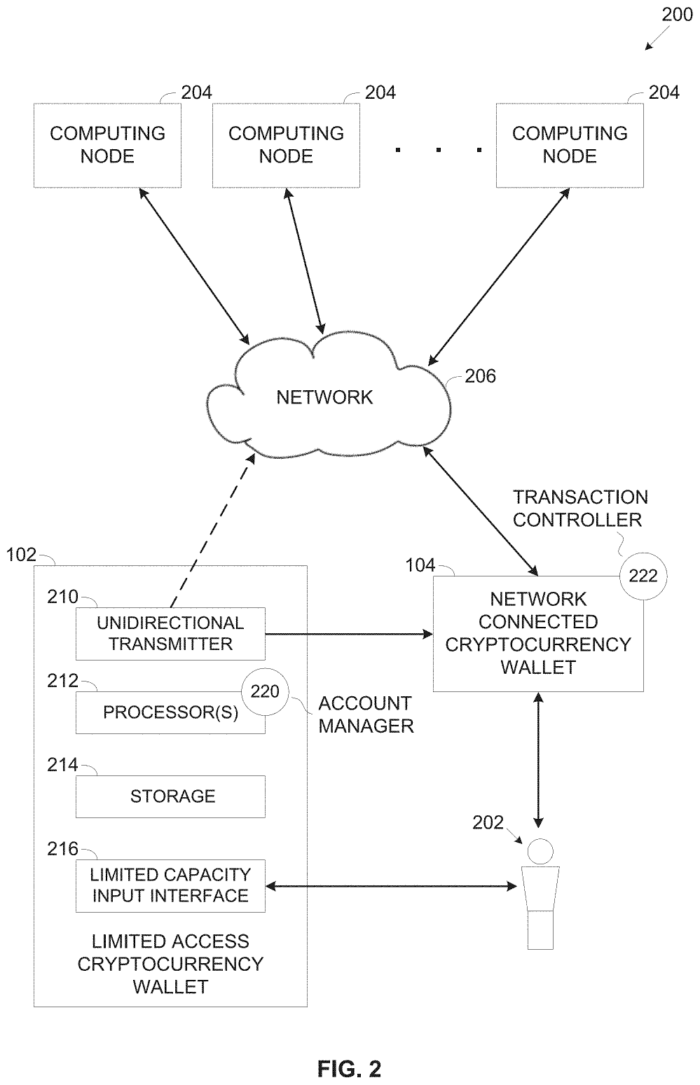

Reference is also made to FIG. 2, which is a schematic illustration of an exemplary system for transferring cryptocurrency funds from an account associated with a limited access cryptocurrency wallet to one or more other accounts without physically attending to the limited access cryptocurrency wallet device, according to some embodiments of the present invention.

An exemplary system 200 may include a limited access cryptocurrency wallet such as the limited access cryptocurrency wallet 102 adapted to store cryptocurrency funds of an associated user 202.

The cryptocurrency service may be regulated by a community network comprising a plurality of computing nodes 204, for example, a blockchain network maintaining a distributed ledger blockchain to track, log and record cryptocurrency transactions.

The computing nodes 204, for example, a computer, a server, a processing node, a network node, a cloud computing resource, a Smartphone, a tablet and/or the like may communicate with each other via a network 206 comprising one or more wired and/or wireless networks, for example, a Local Area Network (LAN), a Wide Area Network (WAN), a Municipal Area Network (MAN), a Wireless LAN (WLAN), a cellular network, the internet and/or the like.

According to some embodiments of the present invention, the limited access cryptocurrency wallet 102 may be an isolated device, for example, a proprietary device, a custom device and/or the like which is isolated from the network 206, specifically in terms of receiving data from the network 206. In particular, the isolated device may facilitate a cold wallet associated with one or more accounts of the user 202 to store cryptocurrency funds of the associated user 202. Since the cold wallet is an isolated device disconnected and thus isolated from the network 230 at least on the receive side, the cold wallet may be highly immune to network based malicious attacks directed to compromise the cold wallet in order to gain access and control of its stored account(s) and possibly transfer cryptocurrency funds out of the cold wallet and steal them.

The limited access cryptocurrency wallet 102 may be an isolated device having transmit-only communication capabilities and may therefore comprise a unidirectional transmitter 210 to facilitate a unidirectional (one-way) secure communication channel with one or more other devices, a processor(s) 212 for executing a process such as the process 110 and storage 214 for storing program code (program store) and/or data. The isolated device may further include one or more interfaces for receiving data, specifically a secure limited capacity input interface 216 for receiving limited and typically very low volume data.

The unidirectional transmitter 210 may include one or more wired, wireless and/or optical transmitting interfaces adapted for data transmittal only and thus unable to receive data. The unidirectional transmitter 210 may be physically tamper resistant such that compromising data transmitted from the unidirectional transmitter 210 is impossible and/or detectable and reported. The unidirectional transmitter 210 may include for example, a light based (e.g. infrared, laser, etc.) transmitter configured for optically encoding data. In particular, the unidirectional transmitter 210 may transmit a directed light pattern directed to a specific receiver which may not be intercepted by potentially (eavesdropping) malicious devices. In another example, the unidirectional transmitter 210 may include a wired and/or wireless transmitter, for example, a serial transmitter, a Radio Frequency (RF) transmitter configured for transmitting data over wire and/or over the air. In another example, the unidirectional transmitter 210 may include a display, for example, a screen, a projector and/or the like for displaying a QR code encoding data which may be scanned and recovered for transmission to one or more of the computing nodes 204. In another example, the unidirectional secure communication channel may be implemented using a hardware storage media, for example, a CD-ROM disk and/or the like preferably a onetime use disposable disk. In such case, the unidirectional transmitter 210 may include a media access interface adapted for writing, burning and/or programming data to the hardware storage media. The burned hardware storage media may be then provided to the one or more of the computing nodes 204 thus securely transferring data from the isolated device 202 to the computing nodes 204.

Moreover, the unidirectional transmitter 210 may transmit encrypted data thus forming a reliable and secure unidirectional (one-way) communication channel.

The processor(s) 212, homogenous or heterogeneous, may include one or more processing nodes arranged for parallel processing, as clusters and/or as one or more multi core processor(s). The storage 214 may include one or more non-transitory memory devices, either persistent non-volatile devices, for example, a ROM, a Flash array, a hard drive, an SSD, a magnetic disk and/or the like and/or one or more volatile devices, for example, a RAM device, a cache memory and/or the like.

The processor(s) 212 may execute one or more software modules such as, for example, a process, a script, an application, an agent, a utility, a tool and/or the like each comprising a plurality of program instructions stored in a non-transitory medium (program store) such as the storage 214 and executed by one or more processors such as the processor(s) 212.

The account manager 220 may further utilize and/or facilitate one or more hardware elements integrated and/or coupled with the isolated device 202, for example, a circuit, a component, an Integrated Circuit (IC), an Application Specific Integrated Circuit (ASIC), a Field Programmable Gate Array (FPGA), a Digital Signals Processor (DSP) and/or the like. For example, the account manager 220 may use a random number generator for creating one or more encryption keys, for example, an asymmetric encryption key pair comprising a private key and a public key as known in the art. In another example, the account manager 220 may use a Hardware Security Module (HSM) to utilize one or more functions, for example, message signing, key injection, database encryption and/or the like.

The processor(s) 212 may therefore execute one or more functional modules utilized by one or more software modules, one or more of the hardware modules and/or a combination thereof. For example, the processor(s) 212 may execute an account manager application 220 for executing the process 110.

The limited capacity input interface 216 may be configured to receive limited and typically very low volume of data which may be manually and/or automatically inserted. For example, the limited capacity input interface 216 may include one or more user interfaces such as, for example, a keyboard, a touchscreen and/or the like for interacting with the user 202 to receive textual strings of data typed in by the associated user 202. In another example, the limited capacity input interface 216 may include a computer punched card reader configured to read data, for example, strings encoded in one or more punched cards inserted manually and/or automatically to the computer punched card reader. The user interface may further include one or more output interfaces, for example, a display, a speaker, an earphone and/or the like for outputting data to the user 202.

However, according to some embodiments of the present invention, the limited access cryptocurrency wallet 102, for example, a computer, a server, a Smartphone, a tablet and/or any other computing device comprising one or more processor(s) may be a hot wallet associated with one or more accounts of the user 202 for storing cryptocurrency funds of the associated user 202. The limited access cryptocurrency hot wallet 102 may be very similar to the network connected cryptocurrency wallet 104 with one or more exceptions. For example, since by nature it is supposed to communicate with the network 206, the limited access cryptocurrency hot wallet 102 may include a two-way network interface for transmitting/receiving data to/from the network 206, for example, to communicate with one or more of the computing noes 204. However, for one or more reasons the user 202 may disconnect the hot wallet from the network 206, for example, to secure the hot wallet by placing it in a secure and inaccessible location where the hot wallet is isolated from the network 206. In another example, the limited access cryptocurrency hot wallet 102 may include one or more high capacity interfaces, for example, a Universal Serial Bus (USB) port, an RF interface and/or the like for transmitting and/or receiving large volumes of data.

Moreover, according to some embodiments of the present invention, the limited access cryptocurrency wallet 102 may be utilized and/or implemented by a group of computing nodes such as the computing nodes 204 which may engage in one or more MPC sessions using one or more MPC protocols as known in the art to execute the process 120, for example, Shamir secret sharing and/or the like to execute the process 100. In particular, after executing the process 100, the group of computing nodes utilizing the limited access cryptocurrency wallet 102 may be disconnected from the network 206, for example, to secure the computing nodes by placing them in a secure and inaccessible location where the computing nodes are isolated from the network 206.

The system may further include a network connected cryptocurrency wallet such as the network connected cryptocurrency wallet 104, for example, a computer, a server, a Smartphone, a tablet and/or any other computing device comprising one or more processor(s) connected to the network 206. The network connected cryptocurrency wallet 104 may be associated with the user 202. For example, the network connected cryptocurrency wallet 104 may be a hot wallet of the user 202. In another example, the network connected cryptocurrency wallet 104 may simply be a networked device used and operated by the user 202.

The network connected cryptocurrency wallet 104 may include a network interface for connecting to the network 206 and communicating with one or more networked resources connected to the network 206, for example, one or more of the computing nodes 204. The network connected cryptocurrency wallet 104 may also include a processor(s) such as the processor(s) 212 for executing the process 120 and a storage such as the storage 214 for storing code (program store) and/or data. The network connected cryptocurrency wallet 104 may further include one or more of the hardware modules, for example, a circuit, a component, an IC, an ASIC, an FPGA, a DSP and/or the like.

The network connected cryptocurrency wallet 104, specifically the processor(s) of the network connected cryptocurrency wallet 104 may therefore execute one or more functional modules utilized by one or more software modules, one or more of the hardware modules and/or a combination thereof. For example, the network connected cryptocurrency wallet 104 may execute a transaction controller 222 for executing the process 120.

Optionally, the network connected cryptocurrency wallet 104 is implemented by a subset of the plurality of networked computing nodes 204 which may engage in one or more MPC session using one or more MPC protocols as known in the art to execute the process 120, for example, Shamir secret sharing and/or the like.

As described herein before, the data transmitted by the limited access cryptocurrency wallet 102 over the unidirectional secure communication channel facilitated by the unidirectional transmitter 210 may be encrypted. Applying one or more encryption schemes, the limited access cryptocurrency wallet 102 may establish a unidirectional secure and reliable channel with each of one or more networked resources connected to the network 206, for example, one or more of the computing nodes 204. For example, the limited access cryptocurrency wallet 102 may use an encryption-decryption key pair uniquely associated with each of at least some of the computing nodes 204 to encrypt the data transmitted to the respective computing node 204. The limited access cryptocurrency wallet 102 may be also associated with such an encryption-decryption key pair to enable the computing nodes 204 to verify and/or authenticate data transmitted by the limited access cryptocurrency wallet 102 as known in the art. The encryption-decryption key pairs may include, for example, an asymmetric cryptographic key pair comprising a private key and a public key and/or the like. The public key of the asymmetric cryptographic key pair associated with each computing node 204 as well as the limited access cryptocurrency wallet 102 is publicly shared while the private key of the asymmetric cryptographic key pair of the key pair is kept secret and is therefore only available to the respective device which, using its private key, is the only device capable of decrypting messages addressed to it.

For brevity, the processes 110 and 120 as well as the system 200 are described herein for a single limited access cryptocurrency wallet 102 associated with a single user 202 and a single network connected cryptocurrency wallet 104 supporting the limited access cryptocurrency wallet 102. However, this should not be construed as limiting since the processes 110 and 120 as well as the system 200 may be expanded to support a plurality of limited access cryptocurrency wallet 102 associated with respective users 202 and supported by one or more network connected cryptocurrency wallet 104.

Also, for clarity the limited access cryptocurrency wallet 102 and the network connected cryptocurrency wallet 104 are described herein after to execute the processes 110 and 120 respectively. However, it should be clear that the account manager 220 executed by the processor(s) 212 of the limited access cryptocurrency wallet 102 is the functional module which in fact executes the process 110 while the transaction controller 222 executed by the processor(s) of the network connected cryptocurrency wallet 104 is the functional module which in fact executes the process 120.

As shown at 112, the process 110 executed by the limited access cryptocurrency wallet 102 starts with the creating one or more provisional accounts each allocated for a respective recipient to whom the user 202 may wish to transfer cryptocurrency funds in the future.

By its nature, the provisional account is a temporary account intended for a specific use and is thus allocated (associated) for a specific recipient for a limited time period. However, optionally, the limited access cryptocurrency wallet 102 may set one or more actual accounts (main accounts) associated with the limited access cryptocurrency wallet 102 as one or more of the provisional accounts. In such case, the limited access cryptocurrency wallet 102 may create no new accounts and may simply use its associated actual account(s) as one or more of the provisional accounts.

As shown at 114, the limited access cryptocurrency wallet 102 may transmit a transaction of a predefined overall value of cryptocurrency from one or more (origin) accounts associated with the limited access cryptocurrency wallet 102 to each provisional account. The transaction of the predefined overall value is recorded by the computing nodes 204 in the blockchain.

Typically, the overall value may be significantly large since it may be used for transferring cryptocurrency funds to the respective recipient over a relatively long time period during which the limited access cryptocurrency wallet 102 is remote, for example, stored in a secure location such as, for example, a safe, a restricted location and/or the like where the limited access cryptocurrency wallet 102 is physically inaccessible, i.e. the user does not physically attend to it.

As shown at 116, the limited access cryptocurrency wallet 102 may generate a plurality of signed transactions for transferring a plurality of predefined partial values of cryptocurrency from each provisional account to a respective receiving account allocated for a respective recipient. This means that for each provisional account allocated for a respective recipient, the limited access cryptocurrency wallet 102 may generate a respective set of a plurality of signed transactions for transferring predefined partial values of cryptocurrency from the respective provisional account to the respective receiving account.

Each of the plurality of signed transactions generated by the limited access cryptocurrency wallet 102 may be configured for transferring a predefined partial value of the overall value of cryptocurrency initially transferred to the respective provisional account such that a sum of the plurality of predefined partial values does not exceed the predefined overall value. Each signed transaction may include at least an account identifier (ID) of the respective provisional account, an account ID of the respective receiving account, a predefined partial value of cryptocurrency and a signature of the limited access cryptocurrency wallet device 102. One or more of the signed transactions may further include one or more additional data items, fields, flags and/or the like as defined by the cryptocurrency in use. The limited access cryptocurrency wallet 102 may sign each signed transaction using its unique private key, for example, compute a hash value for each transaction using one or more hash functions as known in the art. The signed transactions are thus valid transactions of cryptocurrency from the provisional account to the respective receiving account and may not be generated and/or replicated by any other party since the private key is only available to the limited access cryptocurrency wallet.

The plurality of partial values allocated for each provisional account may be predefined according to one or more rules, for example, a predefined granularity of the partial values, for example, 1 cryptocurrency unit, 2 cryptocurrency units, 3 cryptocurrency units, and so on to a certain large number of cryptocurrency units. Moreover, the plurality of predefined partial values may be simultaneously valid until one or more signed transactions are transmitted to the respective receiving account as described in detail herein after. However, a sum of the plurality of partial values transferred from the respective provisional account to the respective receiving account cannot exceed the overall value of cryptocurrency stored in the respective provisional account.

Moreover, the limited access cryptocurrency wallet 102 may further generate a plurality of signed excess transactions for transferring one or more predefined values of cryptocurrency from one or more of the provisional account back to the account associated with the limited access cryptocurrency wallet 102. This may allow transmitting cryptocurrency funds stored in the provisional account(s), for example, an excess value, a leftover value, a final balance and/or the like back to the account of the limited access cryptocurrency wallet 102.

Optionally, in case the limited access cryptocurrency wallet 102 created a plurality of provisional accounts each allocated for a respective one of the plurality of receiving accounts, the limited access cryptocurrency wallet 102 may further generate a plurality of signed transactions for transferring predefined values of cryptocurrency from one or more of the provisional accounts to another one or more of the provisional accounts. This may allow dynamically transferring cryptocurrency funds between the provisional accounts without requiring the limited access cryptocurrency wallet 102 to generate additional signed transactions.

Transferring cryptocurrency between the provisional accounts may be implemented using one or more methods, techniques and/or implementations. For example, the limited access cryptocurrency wallet 102 may generate a plurality of signed transactions for transferring predefined values of cryptocurrency from one or more specific provisional accounts to one or more other provisional accounts.

For example, assuming there are three provisional accounts each allocated for a respective recipient. The limited access cryptocurrency wallet 102 may generate a plurality of signed transactions for transferring predefined values of cryptocurrency from the first provisional account to the second and third provisional accounts. The limited access cryptocurrency wallet 102 may further generate a plurality of signed transactions for transferring predefined values of cryptocurrency from the second provisional account to the first and third provisional accounts and may further generate a plurality of signed transactions for transferring predefined values of cryptocurrency from the third provisional account to the first and second provisional accounts. Such a point-to-point implementation may allow for increased flexibility and but may the limited access cryptocurrency wallet 102 to generate an extremely large number of singed transactions.

In another example, the limited access cryptocurrency wallet 102 may apply a token-ring like approach in which, the limited access cryptocurrency wallet 102 may generate a plurality of signed transactions for transferring predefined values of cryptocurrency from the first provisional account to the second provisional account, from the second provisional account to the third provisional account and from the third provisional account back to the first provisional account. This token-ring implementation may significantly reduce the number of singed transactions generated by the limited access cryptocurrency wallet 102 but may require multiple transactions in real-time to move cryptocurrency funds between the provisional accounts. For example, in order to move a certain value of cryptocurrency from the first provisional account to the third provisional account, one or more signed transactions may be transmitted for transferring cryptocurrency from the first provisional account to the second provisional account followed by one or more additional signed transactions transmitted for transferring cryptocurrency from the second provisional account to the third provisional account.

The limited access cryptocurrency wallet 102 may set the partial values of the signed transactions generated for transferring cryptocurrency between the plurality of provisional accounts according to a relatively low granularity to reduce the number of these signed transactions. Reducing the granularity may reduce the flexibility in the values that may be moved between the provisional accounts but it may be considered a minor limitation since all these provisional accounts are associated with and owned by the limited access cryptocurrency wallet 102 compared to the signed transactions generated for transferring cryptocurrency to the receiving account(s) which may require high flexibility and hence high granularity.

Optionally, the limited access cryptocurrency wallet 102 may generate at least some of the plurality of signed transactions in a gradual process. For example, the limited access cryptocurrency wallet 102 may create the signed transactions, set the input and output values, and optionally one or more additional data items such as, for example, a field, a flag and/or the like as defined by the cryptocurrency service protocol before informed of the receiving account(s). when provided with the receiving account, for example, by the user 202, the limited access cryptocurrency wallet 102 may finalize generation of the signed transactions by including the receiving account ID, for example, the public key and sign the signed transactions. generating the signed transactions gradually with no user intervention in the first step may significantly reduce the time for completing the generation of the signed transaction after provided with the details of the receiving account(s).

As shown at 118, the limited access cryptocurrency wallet 102 may transmit the plurality of signed transactions generated for each provisional account to the network connected cryptocurrency wallet 104. The signed transactions are not recorded in the blockchain but are rather only stored by the network connected cryptocurrency wallet 104. Later, in real-time, when operated, instructed and/or requested to transfer cryptocurrency funds to one or more of the receiving account(s), the network connected cryptocurrency wallet 104 may transmit one or more of the signed transactions to make the cryptocurrency transfer. This is further described in detail herein after.

The limited access cryptocurrency wallet 102 may transmit the plurality of signed transactions to the network connected cryptocurrency wallet 104 via the secure unidirectional transmitter 210.

As stated herein before, the network connected cryptocurrency wallet 104 may be utilized by a single device connected to the network 206. Optionally, the network connected cryptocurrency wallet 104 may be utilized by a group of multiple commuting nodes such as the computing nodes 204 connected to the network 206 which may engage in one or more Multi-Party Computation (MPC) sessions to jointly execute the process 120 and transmit one or more of the plurality of signed transactions for transferring cryptocurrency funds from one or more of the provisional accounts to one or more respective receiving accounts. The group of multiple commuting nodes 204 may engage in the MPC session(s) using one or more MPC algorithms, protocols and/or techniques as known in the art, for example, Shamir secret sharing and/or the like. This may significantly increase security and immunity of the cryptocurrency funds stored in the provisional account(s) since implementing the network connected cryptocurrency wallet 104 as a group of computing nodes 204 may prevent any single device from solely transmitting any of the signed transactions without the consent of the group.

Therefore, in case the network connected cryptocurrency wallet 104 is utilized by a single device, the limited access cryptocurrency wallet 102 may transmit the signed transactions to the single device network connected cryptocurrency wallet 104 either via the secure channel established with the network connected cryptocurrency wallet 104 over the network 206 and/or by connecting directly to the network connected cryptocurrency wallet 104. In case the network connected cryptocurrency wallet 104 is utilized by a group of computing nodes, the limited access cryptocurrency wallet 102 may transmit the signed transactions via the secure unidirectional transmitter 210 connected to the network 206 connecting the group of computing nodes 204.

From this point on the limited access cryptocurrency wallet 102 is no longer needed and may be stored in a limited access location, for example, a safe, a restricted location and/or the like to ensure security of the cryptocurrency funds stored by the limited access cryptocurrency wallet 102. Since it is remotely stored, the limited access cryptocurrency wallet 102 may be physically inaccessible and thus cannot be physically operated and/or attended by the user 202.

As shown at 122, the process 120 executed by the network connected cryptocurrency wallet 104 starts with receiving the plurality of signed transactions generated by the limited access cryptocurrency wallet 102 for transferring cryptocurrency funds, specifically the plurality of predefined partial values to one or more of the provisional accounts allocated for one or more of the receiving accounts.

As shown at 124, the network connected cryptocurrency wallet 104 may transmit one or more of the signed transactions for transferring cryptocurrency funds from one or more of the provisional accounts to one or more respective receiving accounts associated with one or more respective recipients.

The network connected cryptocurrency wallet 104 may transmit one or more of the signed transactions, for example, in response to an instruction received from the user 202 associated with the limited access cryptocurrency wallet 102 who may wish to transfer cryptocurrency to one or more of the recipients. In another example, the network connected cryptocurrency wallet 104 may transmit one or more of the signed transactions automatically in response to one or more trigger events, for example, a predefined scheduled time, an action conducted by one or more of the recipients, a transaction and/or other event detected in the blockchain network and/or the like.

The network connected cryptocurrency wallet 104 may select to transmit one or more of the signed transactions according to the partial value(s) of the selected signed transaction(s) with respect to a certain value of cryptocurrency that the network connected cryptocurrency wallet 104 is required to transfer to the respective receiving account. In particular, the network connected cryptocurrency wallet 104 selects one or more of the plurality of signed transaction having a predefined partial value, specifically a cumulative predefined partial value which is equal or exceeding the certain cryptocurrency value that needs to be transferred.

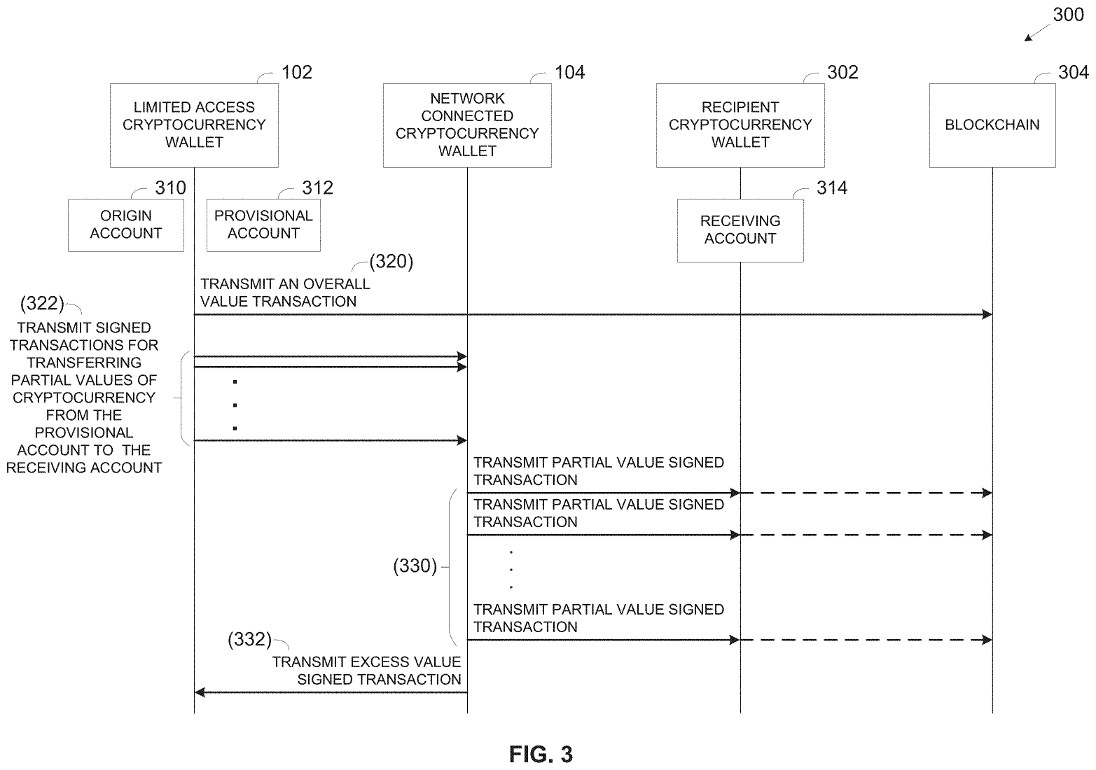

Reference is now made to FIG. 3, which is a schematic illustration of an exemplary sequence of transferring cryptocurrency funds from an account associated with a limited access cryptocurrency wallet to one or more other accounts without physically attending to the limited access cryptocurrency wallet device, according to some embodiments of the present invention.

An exemplary sequence 300 presents a sequence in which a limited access cryptocurrency wallet such as the limited access cryptocurrency wallet 102 executes a process such as the process 110 for creating, in advance, provisions and means for future transfer of cryptocurrency funds to a certain receiving account 314 without physically accessing and operating the limited access cryptocurrency wallet 102. A network connected cryptocurrency wallet such as the network connected cryptocurrency wallet 104 executing a process such as the process 120 may be later (in real-time) instructed, for example, by a user such as the user 202 to use the provisions and means created by the limited access cryptocurrency wallet 102 to transfer cryptocurrency funds to the certain receiving account 314 without the need to physically attend and operate the limited access cryptocurrency wallet 102.

As seen in the sequence 300, the limited access cryptocurrency wallet 102 may initially transmit (320) one or more transactions for transferring an overall value of cryptocurrency from an origin account 310 associated with the limited access cryptocurrency wallet 102 to a provisional account 312 allocated for a certain recipient as described in steps 112 and 114 of the process 110. These transactions may be typically recorded in a blockchain 304 maintained to regulate the cryptocurrency service.

The limited access cryptocurrency wallet 102 may then transmit (322) to the network connected cryptocurrency wallet 104 a plurality of signed transactions generated for transferring predefined partial values of the overall value from the provisional account 312 to a receiving account 314 associated with the certain recipient as described in step 116 and 118 of the process 110. Specifically, the receiving account 314 may be associated and controlled by a cryptocurrency wallet 302 used by the certain recipient.

The network connected cryptocurrency wallet 104 which is typically associated with the user 202 may be later instructed, triggered and/or otherwise operated, for example, by the user 202, by a scheduled trigger event and/or the like to transmit (330) one or more of the signed transaction to transfer the respective partial values defined by these signed transactions from the provisional account 312 to the receiving account 314 as described in step 124 of the process 120. One or more of these transactions may be recorded in the blockchain 304. However, in some embodiments of the present invention, for example, in case of the intermediate signed transactions generated for the payment channel 2-2 multisig provisional account 312, some of the transactions may not be recorded in the blockchain 304 but may rather replace previously transmitted intermediate transactions as described herein before in detail.

Optionally, when closing the provisional account 312, the network connected cryptocurrency wallet 104 transmit (332) one or more signed excess transactions generated in advance by the limited access cryptocurrency wallet 102 to transfer excess cryptocurrency remaining in the provisional account 312 to an account associated with the limited access cryptocurrency wallet 102, for example, the origin account 310.

As evident, the steps 320 and 322 may be executed in advance by the limited access cryptocurrency wallet 102 to create the provisions and means for the future transfer of cryptocurrency funds to the receiving account 314. The steps 330 and 332, however, may be executed later in real-time by the network connected cryptocurrency wallet 104 which is configured to use the created provisions for transferring cryptocurrency to the receiving account 314 without the need to physically access, attend and/or operate the limited access cryptocurrency wallet 102 which may be thus stored in a secure location.

The provisional account(s) may be created according to one or more techniques, algorithms, provisions and/or features applicable (i.e., available, supported, etc.) for the respective cryptocurrency service applied by the limited access cryptocurrency wallet 102 in the system 200. Moreover, the signed transactions may be generated accordingly based on one or more of the operational, structural and/or functional parameters, features and/or attributes of the provisional account and/or of the cryptocurrency service used in the system 200. Furthermore, the signed transactions transmitted for transferring cryptocurrency funds from the provisional account(s) to the receiving accounts may be selected according to their construction, configuration and/or implementation.

In a first exemplary embodiment, the limited access cryptocurrency wallet 102 may create one or more of the provisional accounts using a payment channel as known in the art, specifically, a 2-2 multisig account (wallet) in which the limited access cryptocurrency wallet 102 is one signing party and the respective recipient is a second signing party. Each 2-2 multisig account requires that each transaction made from the respective provisional account to a receiving account associated with a respective recipient that is recorded in the blockchain will be signed by both the transmitting party, i.e. the limited access cryptocurrency wallet 102 and the receiving party, i.e. the respective recipient.

Optionally, the limited access cryptocurrency wallet 102 configures one or more of the payment channel 2-2 multisig accounts to be time limited accounts each associated with an expiration time. This means that after the expiration time, the limiter access cryptocurrency wallet 102 may extract funds left in the payment channel by itself in one or more transactions recorded in the blockchain without the need for the respective recipient to sign these transaction(s).

There may be scenarios in which one or more of the receiving accounts are associated with respective cryptocurrency wallets of the respective recipients which are not configured to support the payment channel 2-2 multisig account, for example, another wallet having no network connectivity, such as, for example, a stored cold wallet, a hot wallet disconnected from the network, a wallet which is not configured to support multisig and/or the like. Therefore, the limited access cryptocurrency wallet 102 may optionally configure one or more of the payment channel 2-2 multisig provisional accounts to be controlled by another network connected device associated and used by the respective recipient(s). This means that the respective recipient may use his other network connected device, for example, a computer, a laptop, a Smartphone, a tablet and/or the like to sign one or more of the transactions transmitted for transferring cryptocurrency from the payment channel 2-2 multisig account the receiving account associated with the respective recipient.

The 2-2 multisig account protocol defines that a transaction from an origin account to a receiving account is recorded in the blockchain only if both the transmitting party associated with the origin account and the receiving party associated with the receiving account sign the transaction. Therefore, one or more transactions may be transmitted for transferring cryptocurrency from the 2-2 multisig account to the receiving account which are not signed by the recipient who is one of the two signing parties and are thus not recorded in the blockchain and are not subject to commission fees which may be allocated to one or more computing nodes 204 (miners) recording the transaction in the blockchain.

This means that one or more intermediate transactions may be transmitted for transferring cryptocurrency from the 2-2 multisig account to the receiving account to replace previously transmitted intermediate transaction(s) which are not recorded in the blockchain. This may be done by using a current intermediate transaction having the same identification (ID) data as that of a preceding previously transmitted intermediate transaction. The identification data which is similar in the current and in the preceding previous transactions may vary between different cryptocurrencies and may include, for example, same transaction ID, same nonce in account based cryptocurrencies such as, for example, Ethereum, same input(s) ID(s) in transaction based cryptocurrencies such as, for example, Bitcoin and/or the like. Since the current transaction replaces the preceding previous transaction, the value of cryptocurrency transferred in the current intermediate transaction may be therefore the sum of the cryptocurrency value transferred in the preceding previously transmitted intermediate transaction and the value of cryptocurrency desired to be transferred in the current transaction.

The limited access cryptocurrency wallet 102 may therefore generate the plurality of signed transactions to include multiple signed transactions which cannot co-exist, i.e. have the same ID data (e.g. transaction ID, nonce, input(s) ID(s), etc.) with gradually increasing partial values of cryptocurrency. As such, one or more of those transactions may be transmitted, as described herein after, as intermediate transactions replacing preceding previously transmitted intermediate transactions having lower cryptocurrency partial values.

As describe herein before in the process 110, after generated, the limited access cryptocurrency wallet 102 may transmit the plurality of signed transactions to the network connected cryptocurrency wallet 104.

In order to transfer cryptocurrency funds from the payment channel 2-2 multisig provisional account to the respective receiving account, the network connected cryptocurrency wallet 104 may transmit one or more of the signed transaction(s) to the respective recipient, specifically to the cryptocurrency wallet device used by the respective recipient. The network connected cryptocurrency wallet 104 may select the transmitted signed transaction(s) according to one or more parameters, for example, the value of cryptocurrency that needs to be transferred compared to the partial values defined by the plurality of signed transactions.

For example, when requested or instructed to transmit a certain value of cryptocurrency from a certain payment channel 2-2 multisig provisional account to a respective receiving account, the network connected cryptocurrency wallet 104 may select one of the signed transactions which includes a partial cryptocurrency value which is equal or larger than the certain value requested to be transferred.

Moreover, as permitted by the payment channel 2-2 multisig account, it is possible that recipient did not sign a signed transaction previously transmitted to the receiving account. In such case, the previously transmitted signed transaction may be regarded as an intermediate transaction. In such case, the network connected cryptocurrency wallet 104 may select one of the signed transactions to replace the preceding signed transaction transmitted for transferring a second value of cryptocurrency to the receiving account. Specifically, the network connected cryptocurrency wallet 104 may select one of the signed transactions having the same transaction ID as the preceding signed transaction and a partial value which is equal or larger than the sum of the second value (transmitted in the preceding signed transaction) and the certain value requested to be transferred in the current signed transaction.

In order to extract the cryptocurrency stored in the provisional 2-2 multisig account, the respective recipient may sign a most recent signed transaction transmitted by the network connected cryptocurrency wallet 104 for transferring cryptocurrency from the respective provisional account to the respective receiving account. When the respective recipient signs the most recent transmitted signed transaction, this signed transaction is recorded in the blockchain

In case the recipient signs a certain signed transaction and the certain signed transaction is recorded in the blockchain and a succeeding signed transaction needs to be transmitted for transferring cryptocurrency to the respective receiving, the connected cryptocurrency wallet 104 should select and transmit a succeeding signed transaction having a transaction ID different from that of the transaction(s) signed by the respective recipient and recorded in the blockchain.

Moreover, since one or more of the 2-2 multisig provisional accounts may be associated with an expiration time, in case the respective recipient(s) fails to sign one or more of the signed transaction transmitted to his associated receiving account within the expiration time, specifically the most recent transmitted signed transaction, the cryptocurrency funds stored in the respective 2-2 multisig account may be transmitted back to the account associated with the limited access cryptocurrency wallet 102.

Furthermore, in case one or more of the payment channel 2-2 multisig provisional accounts were configured accordingly by the limited access cryptocurrency wallet 102 to support signing of transactions by another network connected device, the respective recipient may use his other network connected device to sign one or more of the signed transactions transmitted by the network connected cryptocurrency wallet 104 for transferring cryptocurrency from the respective 2-2 multisig provisional account to his associated receiving account.

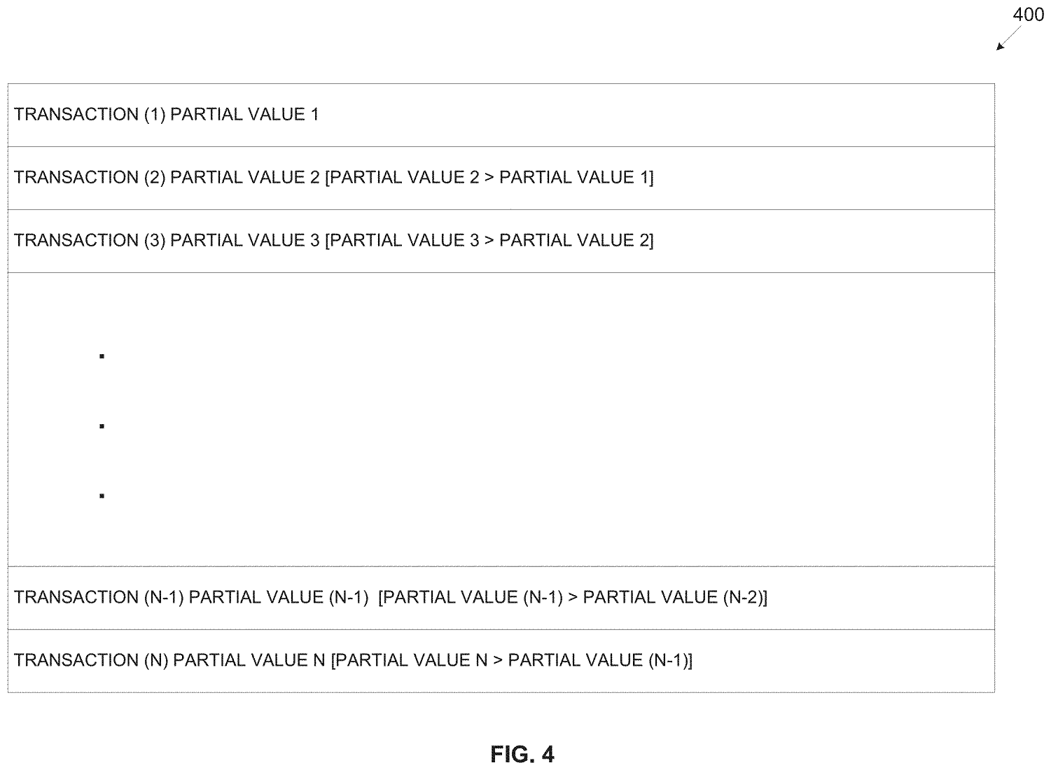

Reference is now made to FIG. 4, which is schematic illustration of an exemplary construction of a plurality of signed cryptocurrency transactions generated in advance for a payment channel provisional account, according to some embodiments of the present invention.

An exemplary predefined transactions collection 400 created by a limited access cryptocurrency wallet such as the limited access cryptocurrency wallet 102 for one or more provisional accounts constructed as 2-2 multisig accounts may include N signed transactions created according to a predefined granularity. Since the as 2-2 multisig protocol supports transmission of one or more intermediate transactions which may not be signed by the respective recipient and hence not recorded in the blockchain, the limited access cryptocurrency wallet 102 may generate the transactions collection 400 to include multiple signed transactions which may not co-exist, for example, have the same transaction ID. The network connected cryptocurrency wallet 104 may therefore transmit one or more signed transactions replacing previously transmitted intermediate signed transactions.

Moreover, the limited access cryptocurrency wallet 102 may generate the singed transactions to include gradually increasing partial values of cryptocurrency. For example, a partial value 2 defined by a signed transaction 2 may be larger than a partial value 1 defined by a signed transaction 1, a partial value 3 defined by a signed transaction 3 may be larger than a partial value 2 defined by a signed transaction 2, and so on to a partial value N defined by a signed transaction N which may be larger than a partial value (N−1) defined by a signed transaction (N−1).

Accordingly, the signed transaction currently transmitted by the network connected cryptocurrency wallet 104 to replace a previously transmitted intermediate signed transaction may include a sum of cryptocurrency included in the previously transmitted intermediate signed transaction and an additional value of cryptocurrency requested for the current cryptocurrency transfer to a receiving account.

In a second exemplary embodiment, the limited access cryptocurrency wallet 102 may create one or more of the provisional accounts as respective new standard cryptocurrency accounts which are associated with the limited access cryptocurrency wallet 102. However, different cryptocurrencies (services, platforms) may be implemented differently and may thus employ different operational, structural and/or functional parameters, features and/or attributes. The limited access cryptocurrency wallet 102 may therefore generate the plurality of signed transactions according to the target cryptocurrency which is used.

For example, some of the cryptocurrencies such as, for example, Ethereum and Ripple are architectured and implemented as an account based cryptocurrency platform or service. Account based cryptocurrency transactions are constructed to include nonces indicative of a number of previous transactions, the value of transferred cryptocurrency and one or more other parameters, flags and/or the like. The limited access cryptocurrency wallet 102 may therefore generate the plurality of signed transactions such that each signed transaction includes a respective nonce indicative of the number of transactions preceding the respective signed transaction and a respective predefined partial value of cryptocurrency.

However, since the limited access cryptocurrency wallet 102 generates the signed transactions in advance, the limited access cryptocurrency wallet 102 is unaware of the cryptocurrency values that will be transmitted from each provisional account and the order of the transactions. The limited access cryptocurrency wallet 102 may be therefore unable to determine which nonce and which partial value to include in each generated signed transaction.

In order to support high flexibility in the transmitted cryptocurrency and their order, the limited access cryptocurrency wallet 102 may generate the set of signed transactions for one or more of the provisional accounts as a flat distribution of the predefined overall value according to a predefined granularity such that each of the plurality of signed transactions includes a respective one of a plurality of valid nonces and a respective predefined partial value of the predefined overall value.

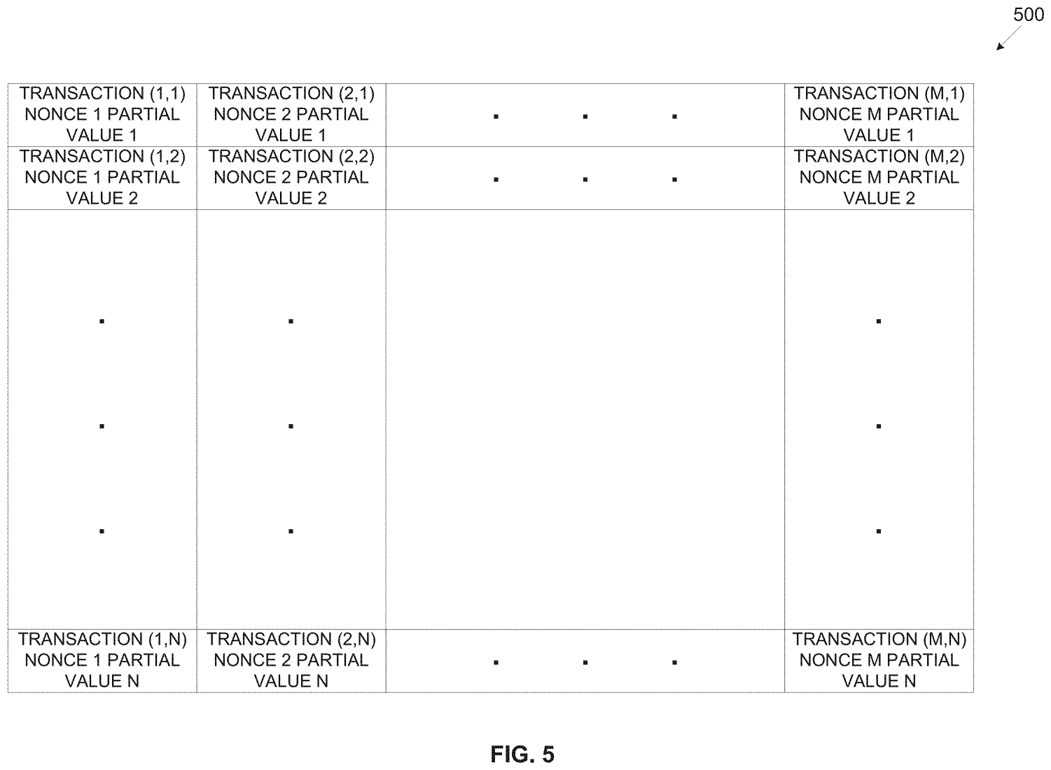

Reference is now made to FIG. 5, which is a schematic illustration of an exemplary construction of a plurality of signed cryptocurrency transactions generated in advance according to a predefined flat distribution for an account based cryptocurrency service, according to some embodiments of the present invention.

An exemplary predefined flat distribution 500 created by a limited access cryptocurrency wallet such as the limited access cryptocurrency wallet 102 for one or more provisional accounts may include a flat distribution of M signed transactions created according to a predefined granularity. Since the nonce included in each signed transaction is indicative of the number of preceding transactions, the signed transactions are ordered according to their nonces starting from transaction 1 to transaction M.

The predefined granularity may define a plurality of partial values 1 through N which summed together do not exceed the predefined overall value of cryptocurrency initially transferred by the limited access cryptocurrency wallet 102 to the respective provisional account. In order to support flexibility in the value if cryptocurrency partial values transmitted from the respective provisional account to the respective receiving account, the limited access cryptocurrency wallet 102 may generate the plurality of signed transactions to include multiple subsets of signed transactions all comprising the same nonce but each comprising a respective predefined partial value where the nonce defines the order of each signed transaction and the respective partial value defines the value transferred by the respective signed transaction.

For example, the limited access cryptocurrency wallet 102 may generate a plurality of first transactions all comprising a first nonce (nonce 1) and each comprising a respective partial value 1 through N such that a 1^{st} first signed transaction(1,1) comprises nonce 1 and partial value 1, a 2^{nd} first signed transaction(1,2) comprises the nonce 1 and partial value 2 and so on to a N^{th} first signed transaction(1,N) which comprises the nonce 1 and partial value N. In another example, the limited access cryptocurrency wallet 102 may generate a plurality of second transactions all comprising a second nonce (nonce 2) and each comprising a respective one of the partial values 1 through N such that a 1^{st} second signed transaction(2,1) comprises nonce 2 and the partial value 1, a 2^{nd} second signed transaction(2,2) comprises the nonce 2 and the partial value 2 and so on to an N^{th} second signed transaction(2,N) which comprises the nonce 2 and the partial value N. In another example, the limited access cryptocurrency wallet 102 may generate a plurality of M^{th} transactions all comprising an M^{th} nonce (nonce M) and each comprising a respective one of the partial values 1 through N such that a 1^{st} M^{th} signed transaction(M,1) comprises nonce M and the partial value 1, a 2^{nd} M^{th} signed transaction(M,2) comprises the nonce M and the partial value 2 and so on to an N^{th} M^{th} signed transaction(M,N) which comprises the nonce M and the partial value N.

As described herein before, the limited access cryptocurrency wallet 102 may create a plurality of provisional accounts associated with a plurality of recipients. In such case, the limited access cryptocurrency wallet 102 generate a plurality of predefined flat distributions such as the predefined flat distribution 500 each for a respective one of the plurality of provisional accounts. The limited access cryptocurrency wallet 102 may generate the different predefined flat distributions 500 to include a common distribution with similar partial values. However, the limited access cryptocurrency wallet 102 may further customize each of the plurality of predefined flat distributions 500 according to respective parameters, for example, a respective granularly, a respective overall value, a respective number of different partial values and/or the like. The respective parameters may reflect the needs and/or patterns and/or the like of the cryptocurrency transfer from the respective provisional account to the respective receiving account associate with the respective recipient for which the respective provisional account is allocated.

Moreover, the limited access cryptocurrency wallet 102 may extend the predefined flat distribution 500 of the predefined overall value for transferring each of the signed transactions to a respective one of a plurality of receiving accounts associate with respective recipients. For example, the limited access cryptocurrency wallet 102 may generate the predefined flat distribution 500 as a multi-dimension distribution by duplicating each of the signed transactions transaction(m,n) (m=1, . . . , M; n=1, . . . , N) where each of the signed transactions is extended to define one of J receiving accounts. As such each signed transaction may be in the form transaction(m,n,j) where j=1, . . . , J indicating a respective receiving account of the J receiving accounts, for example, an address (e.g. public key) of the respective receiving account. In another example, the limited access cryptocurrency wallet 102 may generate a plurality of J predefined flat distributions 500 each allocated for a respective receiving account of the J receiving accounts.

Optionally, the limited access cryptocurrency wallet 102 generates the extended predefined flat distribution(s) 500 to include the account associated with the limited access cryptocurrency wallet 102 as one of the receiving accounts. this means that the limited access cryptocurrency wallet 102 generates the extended predefined flat distribution(s) 500 to include the plurality of signed excess transactions generated to allow transmitting cryptocurrency funds stored in the provisional account(s), for example, an excess value, a leftover value, a final balance and/or the like back to the account of the limited access cryptocurrency wallet 102.

As describe herein before in the process 110, after generated, the limited access cryptocurrency wallet 102 may transmit the plurality of signed transactions to the network connected cryptocurrency wallet 104.

Optionally, the limited access cryptocurrency wallet 102 may transmit only partial data descriptive of the plurality of signed transactions which may be sufficient for the network connected cryptocurrency wallet 104 to derive all information relating to all of the signed transactions. For example, assuming the provisional account is created as the account based cryptocurrency account and the limited access cryptocurrency wallet 102 generates the plurality of signed transactions according to the predefined flat distribution such as, for example, the predefined flat distribution 500. In such case, it may be sufficient for the limited access cryptocurrency wallet 102 to transmit only a very limited information describing the structure of the predefined flat distribution 500, for example, the granularity, a lowest partial value, a highest partial value and/or the like coupled with the signatures of all the signed transactions. The network connected cryptocurrency wallet 104 may then use the received structure information to reconstruct the predefined flat distribution 500 comparing the plurality of signed transactions.

When requested to transmit a certain value of cryptocurrency from the certain provisional account to a respective receiving account, the network connected cryptocurrency wallet 104 may select one of the signed transactions which includes a partial cryptocurrency value which sufficient, i.e. a partial value which is equal or larger than the certain value requested to be transferred.

In particular, the network connected cryptocurrency wallet 104 may select one of the signed transactions according to the number of signed transactions that were already transmitted. For example, assuming the network connected cryptocurrency wallet 104 is instructed to transmit a first signed transaction for transferring cryptocurrency to the respective receiving account for the first time, the network connected cryptocurrency wallet 104 may select the signed transaction comprising the sufficient cryptocurrency value among the set of first signed transactions (1,1) through (1,N).

Moreover, once the network connected cryptocurrency wallet 104 transmits the selected signed transaction, all the other first signed transactions, i.e. all transactions comprising the first nonce (for example, nonce 1) discarded as they are no longer valid since the first nonce was used. In another example, assuming the network connected cryptocurrency wallet 104 is instructed to transmit an i^{th} signed transaction (1<i<M) for transferring cryptocurrency to the respective receiving account for the first time, the network connected cryptocurrency wallet 104 may select the signed transaction comprising the sufficient cryptocurrency value among the set of i^{th} signed transactions (i,1) through (i,N). Moreover, once the network connected cryptocurrency wallet 104 transmits the selected signed transaction, all the other i^{th} signed transactions, i.e. all transactions comprising the i^{th} nonce (for example, nonce i) are discarded as they are no longer valid since the i^{th} nonce was used.

Optionally, the limited access cryptocurrency wallet 102 may create a plurality of provisional accounts in a layered structure. This means that the limited access cryptocurrency wallet 102 may create in advance one or more high level provisional accounts and may transmit one or more transactions to transfer an overall value of cryptocurrency to each such high level provisional account. The limited access cryptocurrency wallet 102 may further create one or more lower level provisional accounts. The limited access cryptocurrency wallet 102 may further generate a plurality of signed transactions from one or more of the high level provisional accounts to one or more of the lower level provisional accounts. The limited access cryptocurrency wallet 102 may then transmit the signed transactions to the network connected cryptocurrency wallet 104. In real-time (while the limited access cryptocurrency wallet 102 is offline and securely stored), the network connected cryptocurrency wallet 104 may be instructed, requested and/or operated to transmit one or more of these signed transactions to transfer cryptocurrency funds from one or more of the high level provisional accounts to one or more of the lower level provisional accounts.

In particular, the limited access cryptocurrency wallet 102 may configure one or more of the lower level provisional accounts as limited value provisional accounts which are limited in the overall value that may be transferred to them. To this end, the limited access cryptocurrency wallet 102 may generate the signed transactions for transferring cryptocurrency to the limited value provisional account(s) to cumulatively have a value which does not exceed the limited overall values assigned to the respective limited value provisional account. The limited access cryptocurrency wallet 102 may extend the layered structure to a plurality of levels and generate a plurality of signed transactions for transferring cryptocurrency from provisional account(s) of each higher level to provisional account(s) of a next lower level.

Applying the layered structure for the provisional accounts may support increased flexibility in the overall values of cryptocurrency that may be transferred to any of the receiving accounts and/or a combination of receiving accounts.

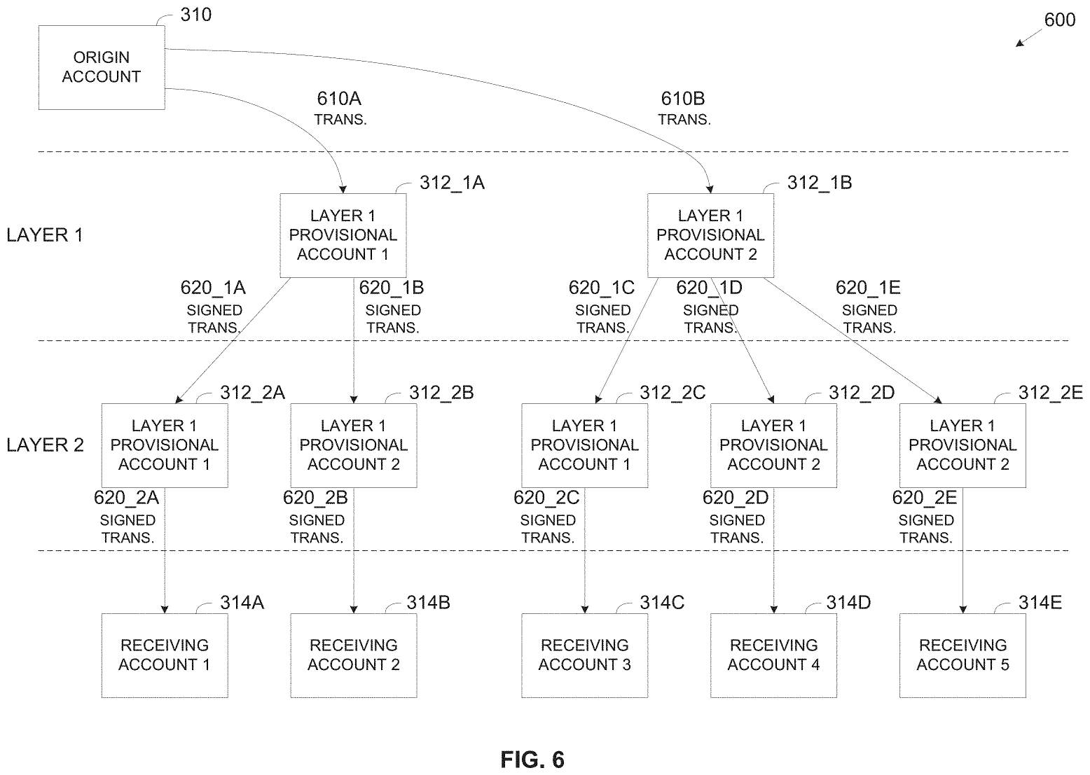

Reference is now made to FIG. 6, which is a schematic illustration of an exemplary construction of a plurality of provisional accounts in a layered structure for an account based cryptocurrency service, according to some embodiments of the present invention. A limited access cryptocurrency wallet such as the limited access cryptocurrency wallet 102 may create a layered structure 600 by creating a plurality of provisional accounts such as the provisional account 312 which are hierarchically arranged in a plurality of layers, for example, a first layer (layer 1) and a second layer (layer 2).

The limited access cryptocurrency wallet 102 may transmit one or more transactions 610 for transferring an initial overall value of cryptocurrency from an origin account such as the origin account 310 associated with the limited access cryptocurrency wallet 102 to one or more of the first layer (high level) provisional accounts 312_1. For example, the limited access cryptocurrency wallet 102 may transmit one or more transactions 610A for transferring a first initial overall value of cryptocurrency to a level provisional accounts 312_1A and one or more transactions 610B for transferring a second initial overall value of cryptocurrency to a level provisional accounts 312_1B. The first and second initial values may be equal or different.

The limited access cryptocurrency wallet 102 may then generate a plurality of signed transactions 620_1 for transferring partial values of the overall value of cryptocurrency from one or more of the first layer provisional accounts 312_1 to one or more second layer (lower level) provisional account 312_2. For example, the limited access cryptocurrency wallet 102 may generate a plurality of signed transactions 620_1A for transferring partial values of the first overall value from the first layer provisional account 312_1A to a first second layer provisional account 312_2A and a plurality of signed transactions 620_1B for transferring partial values of the first overall value from the first layer provisional account 312_1A to a second layer provisional account 312_2B. In another example, the limited access cryptocurrency wallet 102 may generate a plurality of signed transactions 620_1C for transferring partial values of the second overall value from the first layer provisional account 312_1B to a third second layer provisional account 312_2C, a plurality of signed transactions 620_1D for transferring partial values of the second overall value from the first layer provisional account 312_1B to a fourth second layer provisional account 312_2D and a plurality of signed transactions 620_1E for transferring partial values of the second overall value from the first layer provisional account 312_1B to a fifth second layer provisional account 312_2E.

Moreover, the cumulative value of cryptocurrency included in the plurality of signed transactions 620_1 directed for transferring cryptocurrency partial values to each of the second level provisional accounts 312_2 may be limited to a certain predefined value. The overall value of cryptocurrency stored in each second level provisional accounts 312_2 may therefore never exceed the respective predefined value set for the respective second level provisional accounts 312_2. For example, the cumulative value of the partial values of the plurality of signed transactions 620_1A may be limited by a first predefined value set for the second level provisional account 312_2A. In another example, the cumulative value of the partial values of the plurality of signed transactions 620_1D may be limited by a second predefined value set for the second level provisional account 312_2D.

The limited access cryptocurrency wallet 102 may further generate a plurality of signed transactions 620_2 for transferring partial values of cryptocurrency from each of the second layer provisional accounts 312_2 to a respective receiving account such as the receiving account 314. For example, the limited access cryptocurrency wallet 102 may generate a plurality of signed transactions 620_2A for transferring partial values of the value of cryptocurrency stored in the second layer provisional account 312_2A to a first receiving account 314A. In another example, the limited access cryptocurrency wallet 102 may generate a plurality of signed transactions 620_2B for transferring partial values of the value of cryptocurrency stored in the second layer provisional account 312_2B to a second receiving account 314B. In another example, the limited access cryptocurrency wallet 102 may generate a plurality of signed transactions 620_2C for transferring partial values of the value of cryptocurrency stored in the second layer provisional account 312_2C to a third receiving account 314C. In another example, the limited access cryptocurrency wallet 102 may generate a plurality of signed transactions 620_2D for transferring partial values of the value of cryptocurrency stored in the second layer provisional account 312_2D to a fourth receiving account 314B. In another example, the limited access cryptocurrency wallet 102 may generate a plurality of signed transactions 620_2E for transferring partial values of the value of cryptocurrency stored in the second layer provisional account 312_2E to a fifth receiving account 314E.

The limited access cryptocurrency wallet 102 may transmit the plurality of signed transactions 620_1 and 620_2 to the network connected cryptocurrency wallet 104.

In real-time, while the limited access cryptocurrency wallet 102 is no longer accessible, for example, stored in the secure location, the network connected cryptocurrency wallet 104 may be requested, instructed and/or operated to transfer cryptocurrency to one or more of the receiving accounts 314. The network connected cryptocurrency wallet 104 may therefore transmit one or more of the signed 620_2 to transfer cryptocurrency from a respective second layer provisional account 312_2 for transferring cryptocurrency to the respective receiving account 314. However, in order to ensure that there is cryptocurrency in the second layer provisional account 312_2B for transferring to the receiving account 314, the network connected cryptocurrency wallet 104 may first transmit one or more of the signed 620_1 to transfer cryptocurrency from the respective first layer provisional account 312_1 to the second layer provisional account 312_2. For example, assuming the network connected cryptocurrency wallet 104 is instructed to transfer a certain value of cryptocurrency to the receiving account 314B. The network connected cryptocurrency wallet 104 may first transfer cryptocurrency from the first layer provisional account 312_1A to the second layer provisional account 312_2B by transmitting one or more of the signed transactions 620_1B which cumulatively include partial values of cryptocurrency that is equal or greater than the certain value. The network connected cryptocurrency wallet 104 may then transfer cryptocurrency from the second layer provisional account 312_2B to the receiving account 314B by transmitting one or more of the signed transactions 620_2B which cumulatively include partial values of cryptocurrency that is equal or greater than the certain value.

Optionally, the limited access cryptocurrency wallet 102 may create in advance a plurality of provisional accounts in a value oriented hierarchical structure. This means that the limited access cryptocurrency wallet 102 may create the provisional account in advance such that each level of the structure includes a respective provisional account directed for transferring a respective value of cryptocurrency to a plurality of receiving accounts associated with a plurality of recipients. Specifically, the respective value of cryptocurrency allocated for each provisional account is part (e.g. a fraction) of the value allocated to the provisional account in the next higher level.

For example, assuming the limited access cryptocurrency wallet 102 creates the hierarchically structured provisional accounts such that each provisional account is configured and set for transferring half of the value of cryptocurrency allocated for the provisional account of the next higher level. In such case the limited access cryptocurrency wallet 102 may create a first (highest) level provisional account for transferring a certain value of the cryptocurrency to the receiving accounts. The limited access cryptocurrency wallet 102 may further create a second level provisional account for transferring half of the certain value to the receiving accounts. The limited access cryptocurrency wallet 102 may further create a third level provisional account for transferring to the receiving accounts half of the value of the second level provisional account, i.e. a quarter of the certain value and so on to a lowest level provisional account configured for transferring to the receiving accounts a smallest value of the cryptocurrency as defined by the predefined granularity.

After creating the plurality of hierarchically structured provisional accounts, the limited access cryptocurrency wallet 102 may transmit one or more transactions for transferring an initial overall value of cryptocurrency from its associated (origin) account(s) to each of the provisional accounts. For example, the limited access cryptocurrency wallet 102 may transfer a certain overall value to the first level provisional account, half of the certain overall value to the second level provisional account, quarter of the certain overall value to the third level provisional account and so on.

The limited access cryptocurrency wallet 102 may then generate a plurality of signed transactions for transferring values of cryptocurrency from the hierarchically structured provisional accounts to the plurality of receiving accounts. Specifically, the limited access cryptocurrency wallet 102 may generate the signed transactions for transferring from each provisional account cryptocurrency values which are larger than the value of cryptocurrency allocated for the next lower level provisional account and up to the value allocated for the respective provisional account. The limited access cryptocurrency wallet 102 may configure the signed transactions for transferring the values in that range according to a predefined granularity.

For example, assuming the limited access cryptocurrency wallet 102 allocates to each provisional account half of the cryptocurrency allocated to the next higher level provisional account. The limited access cryptocurrency wallet 102 may therefore generate signed transactions for transferring, from the first level provisional account to the plurality of receiving accounts, a plurality of values which in a range that is larger than half of the certain value and smaller (or equal) than the certain value. However, since the values are larger than half the certain value, the value of cryptocurrency allocated for the first level provisional account may suffice for only one such transaction. Assuming there are K receiving accounts, the limited access cryptocurrency wallet 102 may generate a total of M*K/2 signed transactions for transferring the M/2 values of cryptocurrency to the K receiving accounts, i.e. values in the range between the certain value down to half of the certain value. The limited access cryptocurrency wallet 102 may further generate signed transactions for transferring, from the second level provisional account to the plurality of receiving accounts, a plurality of values which in a range that is larger than a quarter of the certain value and smaller (or equal) than half of the certain value. However, since the values are larger than quarter of the certain value, the value of cryptocurrency allocated for the second level provisional account may suffice for only three such transactions. The limited access cryptocurrency wallet 102 may therefore generate a total of 3*M*K/4 signed transactions for transferring M/4 values of cryptocurrency to the K receiving accounts, i.e. values in the range between half of the certain value down to quarter of the certain value. The limited access cryptocurrency wallet 102 may further generate signed transactions for transferring, from the third level provisional account to the plurality of receiving accounts, a plurality of values which in a range that is larger than an eighth of the certain value and smaller (or equal) than quarter of the certain value. However, since the values are larger than eighth of the certain value, the value of cryptocurrency allocated for the third level provisional account may suffice for only seven such transactions. The limited access cryptocurrency wallet 102 may therefore generate a total of 7*M*K/8 signed transactions for transferring M/8 values of cryptocurrency to the K receiving accounts, i.e. values in the range between a quarter of the certain value down to an eighth of the certain value. The limited access cryptocurrency wallet 102 may continue generating additional signed transactions accordingly for the additional lower level provisional accounts created in the hierarchical structure. Generalizing the above, for each provisional account of level i, the limited access cryptocurrency wallet 102 may allocate a value of cryptocurrency which is M/2′. The limited access cryptocurrency wallet 102 may further generate signed transactions for transferring, from the i^{th} level provisional account to the plurality of receiving accounts, a plurality of values which in a range that is larger M/2′¹ and smaller (or equal) than M/2′. Following the same logic described for the higher level provisional accounts, the limited access cryptocurrency wallet 102 may generate a total of (2ⁱ⁺¹)*M*K/(2ⁱ⁺¹) signed transactions for transferring 2ⁱ⁺¹ values of cryptocurrency to the K receiving accounts.

Applying the hierarchically structured provisional accounts may significantly reduce the number of signed transactions that the limited access cryptocurrency wallet 102 needs to generate and transmit to the network connected cryptocurrency wallet 104. This is because the signed transactions for each level provisional account need to be generated for values of cryptocurrency that are confined within the range applicable to the respective level. For the above example, in which the value allocated to the provisional account in each level is half of the value allocated to the provisional account of the next higher level, the overall number of signed transactions generated by the limited access cryptocurrency wallet 102 may be less than M*K*log(M). Division of the value allocated to each level provisional account by half compared to its next higher level provisional account is exemplary and should not be construed as limiting since other division schemes may be applies, for example, division to ½, ⅓, ¼, ⅕, ⅙ and/or the like.

In another example, some of the cryptocurrencies such as, for example, Bitcoin, Bitcoin cash and/or the like are architectured and implemented as a transaction (UTXO) based cryptocurrency platform or service. Transaction based cryptocurrency transactions, comprise, among other parameters, one or more output values of cryptocurrency which are derived from one or more input values of cryptocurrency included in the transaction which are traced back to one or more respective output values of one or more previous transactions. Each such input value may therefore include an ID of a respective previous transaction comprising the output value which in the of the respective input value. The ID of a transaction is defined by the cryptocurrency service in use and may typically include a hash value of the respective transaction and/or the like. However, other implementations may apply according to the protocol(s), algorithm(s) and/or conventions of the cryptocurrency service.

Since each transaction directly depends on one or more preceding transactions, the limited access cryptocurrency wallet 102 may generate the plurality of signed transactions to maintain a valid trail and trace of the input values to their source preceding signed transactions. In particular, the limited access cryptocurrency wallet 102 may generate the plurality of signed transactions to constitute a hierarchical Directed Acyclic Graph (DAG), for example, a tree structure, a directed graph and/or the like comprising the plurality of signed transaction such that each signed transaction is derived from a higher layer signed transaction and includes a Transaction ID (TXID). In particular, each input value of each signed transaction is associated with a TXID of a respective output value of a respective higher layer signed transaction. The limited access cryptocurrency wallet 102 may construct the hierarchical DAG to distribute the predefined overall value according to a predefined granularity.

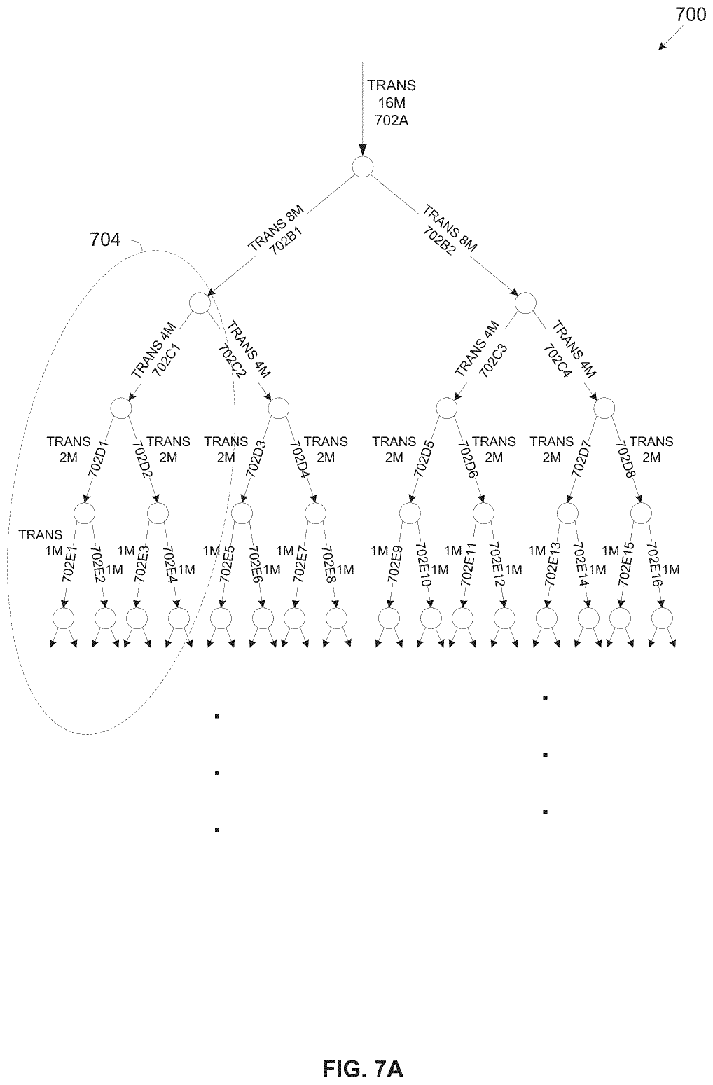

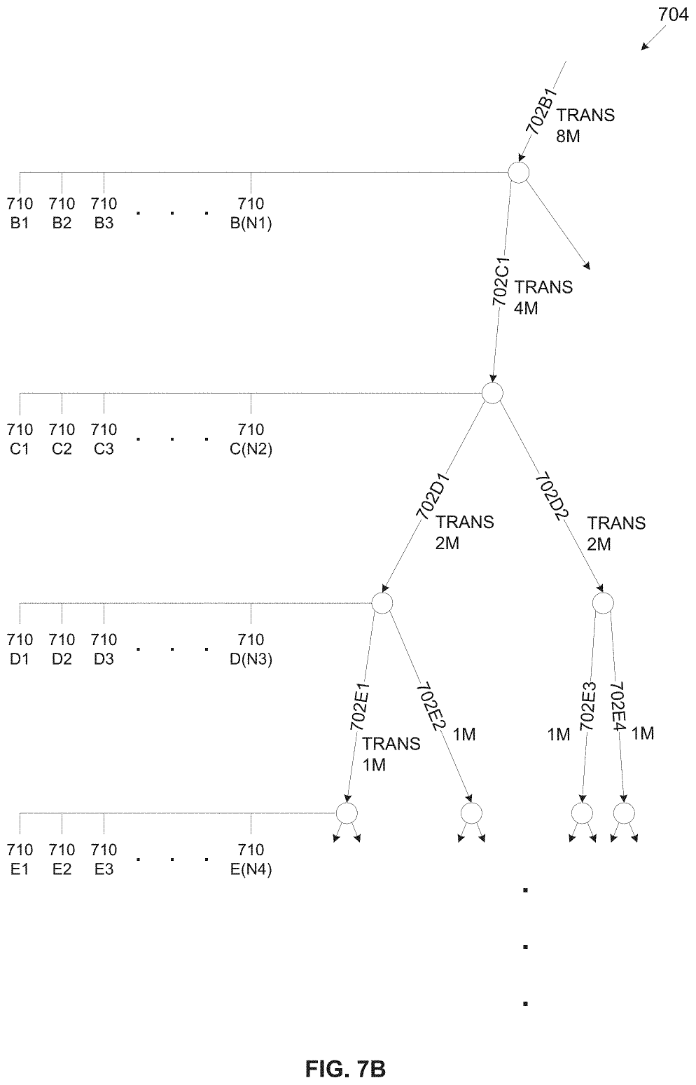

Reference is now made to FIG. 7A and FIG. 7B, which are schematic illustrations of an exemplary hierarchical tree construction of a plurality of signed cryptocurrency transactions generated in advance according to a predefined tree distribution for a transaction based cryptocurrency service, according to some embodiments of the present invention.

As seen in FIG. 7A, an exemplary predefined tree structure 700 created by a limited access cryptocurrency wallet such as the limited access cryptocurrency wallet 102 for one or more provisional accounts may include a hierarchical distribution of signed split transactions 702 generated to transfer the predefined partial values of cryptocurrency back to an account associated with the associated with the limited access cryptocurrency wallet 102, for example, the origin account 310 from which the cryptocurrency was initially transferred to the provisional account. The predefined partial values may be set according to a predefined granularity, for example, each signed split transaction may include half the value of cryptocurrency of its direct higher layer (parent) signed split transaction.

In such an exemplary construction where each signed split transaction is split to two equal parts, each signed split transaction may include an input value which is derived from the output value of its next higher signed split transaction. Each signed split transaction may further include at least two output values of the same cryptocurrency value, where the two output values are directed to an account associated with the limited access cryptocurrency wallet 102, for example, the origin account 310 from which the cryptocurrency was initially transferred to the provisional account.

The edges connecting the vertexes (nodes) in the predefined tree structure 700 may represent the signed split transactions outputs while the vertexes may represent split points which are root points from which signed transactions are derived as described in detail herein after.

For example, assuming the predefined overall value of cryptocurrency initially transferred by the limited access cryptocurrency wallet 102 to a respective provisional account is 16M (million) units of cryptocurrency, i.e. a transaction 702A of 16M units. In such case, the limited access cryptocurrency wallet 102 may generate two second layer signed split transactions 702B1 and 702B2 each comprising half of the 16M units, i.e. 8M units which are directed to the account associated with the limited access cryptocurrency wallet 102. The limited access cryptocurrency wallet 102 may further generate four third layer signed split transactions 702C1, 702C2, 702C3 and 704C4 each comprising half of the 8M units, i.e. 4M units which are directed to the account associated with the limited access cryptocurrency wallet 102. The limited access cryptocurrency wallet 102 may further generate eight fourth layer signed split transactions 702D1, 702D2, 702D3, 702D4, 702D5, 702D6, 702D7 and 704D8 each comprising half of the 4M units, i.e. 2M units which are directed to the account associated with the limited access cryptocurrency wallet 102. The limited access cryptocurrency wallet 102 may further generate 16 fifth layer signed split transactions 702E1, 702E2, 702E3, 702E4, 702E5, 702E6, 702E7, 702E8, 702E9, 702E10, 702E11, 702E12, 702E13, 702E14, 702E15 and 704E16 each comprising half of the 2M units, i.e. 1M units which are directed to the account associated with the limited access cryptocurrency wallet 102. The limited access cryptocurrency wallet 102 may repeat this constriction to a predefined smallest partial value, for example, 1 unit of cryptocurrency. As described herein before, the input value included in each signed split transaction is derived from a respective output value included in a respective higher layer signed split transaction.

As seen in FIG. 7B presenting a segment 704 of the predefined tree structure 700, the limited access cryptocurrency wallet 102 may then generate a plurality of signed transactions 710 each with a respective partial value for transferring cryptocurrency funds from the provisional account to a respective receiving account. Due to the complexity of the predefined tree structure 700, for brevity and clarity only a segment 704 is described here in after. However, the same construction and implementation applies to the entire predefined tree structure 700.

The limited access cryptocurrency wallet 102 may generate a plurality of signed transaction 710 for each of the signed split transactions 702. The plurality of signed transactions generated for each split transaction 702 are visually represented in the predefined tree structure 700 as the edges coming out of the respective split point vertex (node) to which the edge of the respective parent signed split transaction is connected. A number N of signed transactions 710 generated for each signed split transaction 702 may be equal for at least some of the signed split transactions 702 or specific for one or more of the signed split transactions 702. For example, the limited access cryptocurrency wallet 102 may generate N1 signed transactions 710B for the signed split transaction 702B1, N2 signed transactions 710C for the signed split transaction 702C1, N3 signed transactions 710D for the signed split transaction 702D1 and N4 signed transactions 710E for the signed split transaction 702E1.

Each signed transaction 710 may include an input value and two output values, a first output value directed for transferring a certain partial value to the receiving account and a second value which is the excess (difference) between the input value and the first output value which directed for transferring the excess value back to the account associated with the limited access cryptocurrency wallet 102.

The input ID (TXID) of each input of each signed transaction 710 is derived from its parent signed split transaction 702. For example, the input values of signed transactions 710B1 through 710B(N1) is derived from the output value of the signed split transaction 702B1. In another example, the input values of signed transactions 710C1 through 710C(N2) is derived from the output value of the signed split transaction 702C1. In another example, the input values of signed transactions 710D1 through 710D(N3) is derived from the output value of the signed split transaction 702D1. In another example, the input values of signed transactions 710E1 through 710E(N4) is derived from the output value of the signed split transaction 702E1

The limited access cryptocurrency wallet 102 may configure each of the signed transactions to transfer a respective one of the partial values to the receiving account where the partial values are defined according to the predefined granularity, specifically, for each set of signed transactions derived from each signed split transaction. The range of the partial values generated by the limited access cryptocurrency wallet 102 for each layer of the predefined tree structure 700 may start from the value of the respective signed split transaction and end at the value of the next lower layer signed split transaction. For example, the first output of each of the signed transactions 710B1 through 710B(N1) may be set for a respective partial value, for example, 8,000,000 units, 7,999,999 units, 7,999,998 units and so one to 4,000,001 units. Complementary, the second value of each of the signed transactions 710B1 through 710B(N1) may include the difference between the input value and the first output value, specifically, 0 units (no second value), 1 unit, 2 units, and so on to 3,999,999 units. In another example, assuming the layer the first output of each of the signed transactions 710E1 through 710E(N4) may be set for a respective partial value, for example, 1,000,000 units, 999,999 units, 999,998 units and so one to 500,001 unit. Complementary, the second value of each of the signed transactions 710B1 through 710B(N1) may include the difference between the input value and the first output value, specifically, 0 units (no second value), 1 unit, 2 units, and so on to 499,999 units. However, the range of the partial values generated by the limited access cryptocurrency wallet 102 for the bottom most layer (lowest layer) of the predefined tree structure 700 may start from the value of the lowest layer signed split transaction and end at the smallest value defined for transfer to the respective receiving account. For example, assuming lowest layer comprises a plurality of signed split transactions of a value of 100 units and the lowest partial value predefined for transfer to the respective receiving account is 1 unit. In such case, the first output of each of the signed transactions derived from each lowest layer signed split transaction may be set for a respective partial value, for example, 100 units, 99 units, 98 units and so one to 1 unit. Complementary, the second value of each of the signed transactions derived from each of the lowest layer signed split transactions may include the difference between the input value and the first output value, specifically, 0 units (no second value), 1 unit, 2 units, and so on to 99 units.

For brevity, the description of the predefined tree structure 700 does not address commission fees which may need to be allocated to one or more of the computing nodes 204 in reward for recording the respective transaction in the blockchain. Commission fees are described herein after in more detail.

As describe herein before in the process 110, after generated, the limited access cryptocurrency wallet 102 may transmit the plurality of signed split transactions and the plurality of signed transactions to the network connected cryptocurrency wallet 104. As stated herein before, the signed split transactions as well as the signed transactions are not recorded in the blockchain but are rather stored by the network connected cryptocurrency wallet 104.

When requested to transmit a certain value of cryptocurrency from the certain provisional account to a respective receiving account, the network connected cryptocurrency wallet 104 may select at least a segment of the hierarchical DAG which comprises one or more signed transactions having predefined partial values, specifically a cumulative partial value aggregating these partial value(s) which is equal or exceeding the certain value. The network connected cryptocurrency wallet 104 may then transmit the signed transaction(s) included in the selected segment while each signed transaction of the segment which is not transmitted is marked as unusable. The network connected cryptocurrency wallet 104 may select the segment of the DAG to include signed transactions which cumulatively comprise the minimal cryptocurrency value which is equal or larger than the certain value that needs to transferred from the certain provisional account to the respective receiving account. In other words, the network connected cryptocurrency wallet 104 may select one or more of the signed transactions such that a sum of their predefined partial values is the minimal value that is equal or larger than the certain value. However, in order for the selected signed transaction(s) to be valid, i.e. have input values which are traceable to previous transactions, the network connected cryptocurrency wallet 104 may first transmit all the signed split transactions leading (i.e., on the path) to the selected segment of signed transactions selected for transmission in order to transfer the certain value of cryptocurrency to a respective receiving account.

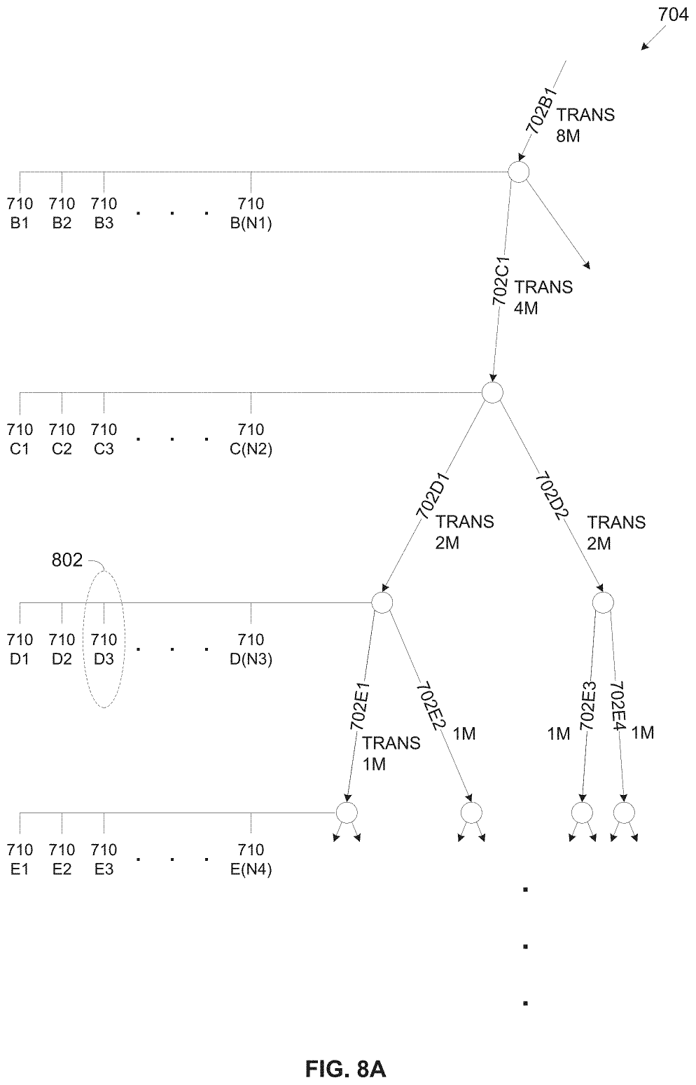

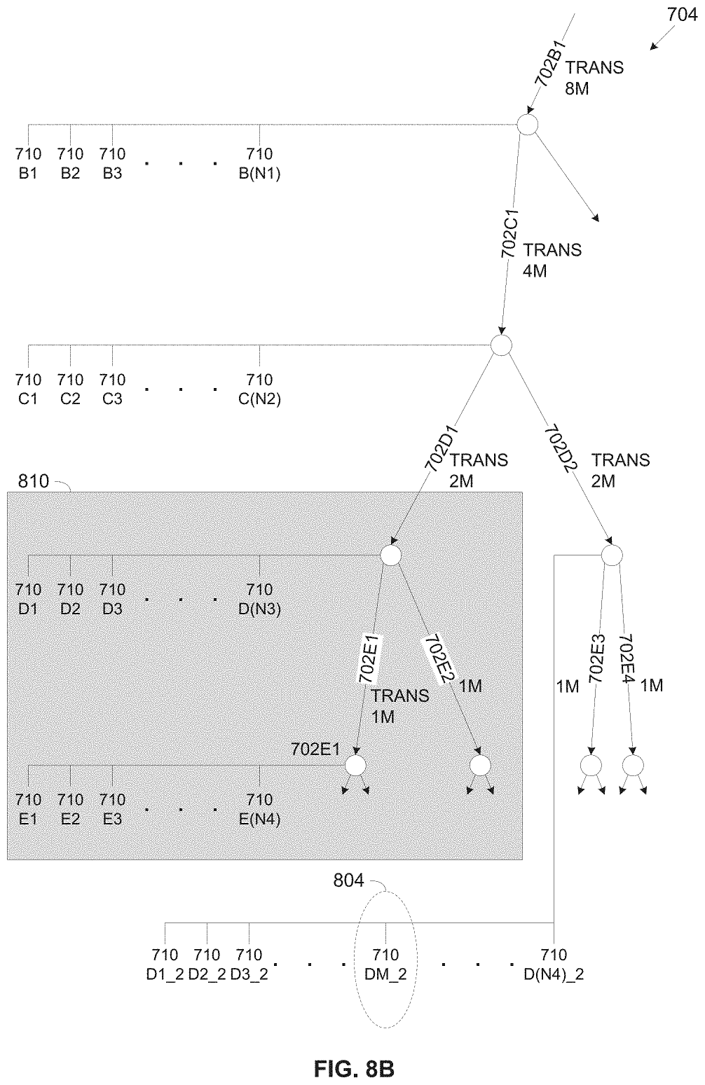

Reference is now made to FIG. 8A and FIG. 8B, which are schematic illustrations of exemplary utilizations of an exemplary hierarchical tree construction for transferring cryptocurrency funds to a receiving account, according to some embodiments of the present invention.

An exemplary predefined tree structure such as the tree structure 700 created by a limited access cryptocurrency wallet such as the limited access cryptocurrency wallet 102 for a certain provisional account created for a transaction based cryptocurrency may be used by a network connected cryptocurrency wallet such as the network connected cryptocurrency wallet 104 for transmitting signed transactions for transferring cryptocurrency funds to a respective receiving account.

When instructed to transfer a certain value of cryptocurrency to the respective receiving account, the network connected cryptocurrency wallet 104 may select a segment of the tree structure 700 comprising one or more signed transactions having a cumulative (aggregated) value of the partial values, which is equal or exceeding the certain value.

For example, assuming the network connected cryptocurrency wallet 104 is instructed to transfer 1,999,998 units of cryptocurrency from the certain provisional account to the respective receiving account. In such case, the network connected cryptocurrency wallet 104 may select a segment 802 comprising the signed transaction 710D3 which includes a first output of 1,999,998 units to the respective receiving account and a second output of 2 units back to the account associated with the limited access cryptocurrency wallet 102. In order to transmit the signed transaction 710D3, the network connected cryptocurrency wallet 104 may first transmit the signed split transactions on the path leading to the signed transaction 710D3, specifically, the signed split transactions 702B1, 702C1 and 702D1 which are thus recorded in the blockchain. After these signed split transactions are transmitted and recorded in the blockchain, the network connected cryptocurrency wallet 104 may transmit the selected signed transaction 710D3 which may now be traced to previous transactions, specifically to the signed split transactions 702D1 which in turn may be traced to the signed split transactions 702C1 which may be traced to the signed split transactions 702B1 which may be traced back to the to the transaction of 16M units initially transmitted by the limited access cryptocurrency wallet 102 to the provisional account.

The network connected cryptocurrency wallet 104 may further mark all the other signed transactions in a branch 810 comprising the selected segment 802 as unusable, specifically the signed transactions in the hierarchical layers which are included in the segment in lower than the selected transactions.

In another example, further assuming that the network connected cryptocurrency wallet 104 is instructed to transfer another 1,500,000 units of cryptocurrency from the certain provisional account to the respective receiving account. Due to the previous transfer in which the signed transaction 710D3 was transmitted, the entire branch 810 is no longer available since the cryptocurrency included in these signed transactions 710 was already transferred in the signed transaction 710D3. In such case, the network connected cryptocurrency wallet 104 may select a segment 804 comprising the signed transaction 710DM_2 which includes a first output of 1,500,000 units to the respective receiving account and a second output of 500,000 units back to the account associated with the limited access cryptocurrency wallet 102. In order to transmit the signed transaction 710DM_2, the network connected cryptocurrency wallet 104 may first transmit the signed split transactions on the path leading to the signed transaction 710DM_2. However, since the signed split transactions 702B1, 702C1 and 702D1 (which is the complementary transaction of 702D2, meaning that 702D2 was also transmitted) were already transmitted to enable transmission of the previous signed transactions 710D3, the network connected cryptocurrency wallet 104 will not transmit any additional transactions except of 710DM_2. The network connected cryptocurrency wallet 104 may then transmit the selected signed transaction 710DM_2 which may be now traced to previous transactions, specifically to the signed split transactions 702D2 which in turn may be traced to the signed split transactions 702C1 which may be traced to the signed split transactions 702B1 which may be traced back to the transaction of 16M units initially transmitted by the limited access cryptocurrency wallet 102 to the provisional account.

As described for the previous example, the network connected cryptocurrency wallet 104 may further mark all the other signed transactions in the branch comprising the selected segment as unusable, specifically the signed transactions in the hierarchical layers which are included in the segment in lower than the selected transactions.

The cryptocurrency wallet used by each of one or more of the recipients, is a network connected cryptocurrency wallet such as the network connected cryptocurrency wallet 104, for example, used by the respective recipient as a hot wallet. In such cases, the network connected cryptocurrency hot wallet of the respective recipient may monitor the blockchain network 206 and may identify the signed transaction(s) transmitted by the network connected cryptocurrency wallet 104 for transferring the partial values to the receiving account associated with the respective recipient.

However, there are cases in which the cryptocurrency wallet used by each of one or more of the recipients, is another limited access cryptocurrency wallet such as the limited access cryptocurrency wallet 102 having no network reception connectivity, for example, used by the respective recipient as a cold wallet. In such case and assuming the cryptocurrency service used in the system 200 is a transaction based cryptocurrency and further a segwit based cryptocurrency, the other limited access cryptocurrency wallet may need to be informed of the value of cryptocurrency transferred to its associated receiving account. In such case, one or more limited length strings may be inserted to the other limited access cryptocurrency wallet 102 via its limited capacity input interface such as the limited capacity input interface 216. The limited length string may comprise a very small number (e.g. <10) of symbols (e.g. characters, digits, etc.) which may be easily inserted via the limited capacity input interface 216 of the limited access cryptocurrency wallet 102, for example, typed by the user 202 using a keyboard of the limited access cryptocurrency wallet 102. Moreover, in segwit base cryptocurrencies the signature is not needed for computing the transaction hash and the limited length string(s) may therefore comprise a description, for example, a hash value of a first signed transaction of the plurality of signed transactions transmitted to the receiving account of (associated with) the other limited access cryptocurrency wallet, a structure of the hierarchical DAG and an index of one or more final signed transactions of the plurality of signed transactions transmitted to the receiving account of (associated with) the other limited access cryptocurrency wallet. The other limited access cryptocurrency wallet may analyze the inserted limited length string(s) to determine the structure of the hierarchical DAG and may thus derive the value of cryptocurrency transferred from the provisional account to the its associated receiving account.

The limited access cryptocurrency wallet 102 may close one or more of the provisional accounts under one or more conditions, for example, when cryptocurrency funds no longer need to be transferred to the respective recipients and the provisional account is therefore no longer needed, after a certain time period and/or the like. The limited access cryptocurrency wallet 102 may apply one or more methods and/or techniques for closing one or more of the provisional accounts.

For example, in case a certain provisional account allocated for a certain recipient is created as the payment channel 2-2 multisig account, the limited access cryptocurrency wallet 102 may transmit an instruction to the network connected cryptocurrency wallet 104 to close the payment channel 2-2 multisig account jointly with the certain recipient as known in the art.

In another example, applicable to account based cryptocurrencies, for example, ripple and/or the like which support closing accounts, the limited access cryptocurrency wallet 102 may transmit an instruction to close the provisional account. Optionally, the limited access cryptocurrency wallet 102 may transmit an instruction to the network connected cryptocurrency wallet 104 to close the provisional account.

In another example, applicable to account based cryptocurrencies, for example, Ethereum and/or the like which do not support explicitly closing accounts, the limited access cryptocurrency wallet 102 may transmit one or more (closing) transactions to its associated account which are recorded in the blockchain. Specifically, the limited access cryptocurrency wallet 102 may transmit closing transaction(s) which include nonces used by one or more of the signed transactions transmitted to the network connected cryptocurrency wallet 104, in particular, the nonce(s) of unused signed transactions. Moreover, the closing transaction(s) may include a cryptocurrency value of zero. As such, since the closing transaction(s) utilize the nonce(s) of the unused signed transaction(s), these nonce(s) become unusable and so do the unused signed transaction(s).

There may be cases in which the provisional account may include an excess and/or leftover of cryptocurrency due to one or more reasons, for example, one or more valid signed transactions were never transmitted and thus never recorded in the blockchain. In such case the excess cryptocurrency left in the provisional account may be transferred back to the account associated with the limited access cryptocurrency wallet 102 using one or more methods and/or techniques.

In one exemplary method, in case the limited access cryptocurrency wallet 102 generated in advance the plurality of signed excess transactions, the network connected cryptocurrency wallet 104 may transmit one or more of these signed excess transactions comprising partial values that cumulatively equal a value of the excess cryptocurrency left in the provisional account. This technique may be easily applied in case the provisional account is created as a new cryptocurrency account. However, in case the provisional account is created as the payment channel 2-2 multisig account, the network connected cryptocurrency wallet 104 may sign jointly with the respective recipient one or more excess transaction for transferring the excess cryptocurrency from the provisional account to the account associated with the limited access cryptocurrency wallet 102. In case the recipient is reluctant to sign such an excess transaction and the payment channel 2-2 multisig account has an expiration time, at the end of the expiration time, the excess cryptocurrency may be transmitted back to the account associated with the limited access cryptocurrency wallet 102.

In another example, in case the provisional account is created as a new account based cryptocurrency account, the value of the excess cryptocurrency may be reported (informed) to the limited access cryptocurrency wallet 102 by inserting the nonce of the most recently transmitted signed transaction, for example, as one or more limited length strings inserted via the limited capacity input interface 216. Based on the nonce of the most recently transmitted signed transaction, the limited access cryptocurrency wallet 102 may derive the value excess cryptocurrency remaining in the provisional account and may transmit one or more transactions, which are recorded in the blockchain, that comprise the excess cryptocurrency value to its associated account.

In another example, in case the provisional account is created as a new transaction based (UTXO) cryptocurrency account, the excess cryptocurrency may include all the unusable and unused signed transactions identified in the hierarchical DAG structure. The value of the excess cryptocurrency may be reported (informed) to the limited access cryptocurrency wallet 102 by inserting the index (transaction ID) of the unusable or unused signed transaction, for example, as one or more limited length strings inserted via the limited capacity input interface 216. Based on the transaction ID of the most recently transmitted signed transaction, the limited access cryptocurrency wallet 102 may derive the value of the excess cryptocurrency remaining in the provisional account and may transmit one or more transactions, which are recorded in the blockchain, that comprise the excess cryptocurrency value to its associated account.

Optionally, in case the hierarchical DAG structure becomes highly segmented due to transmission of a lot of different signed transactions leaving “holes” in the hierarchical DAG structure, the limited access cryptocurrency wallet 102 may be instructed to recycle the hierarchical DAG structure. Specifically, the limited access cryptocurrency wallet 102 may be instructed to recycle the hierarchical DAG structure using the value of the excess cryptocurrency value reported back to the limited access cryptocurrency wallet 102 via the limited capacity input interface 216.

According to some cryptocurrency blockchain protocols, one or more of the transactions transmitted in the blockchain network may include a commission fee allocated to one or more of the computing nodes 204 in reward for recording the respective transaction in the blockchain. However, the value of the commission (fee) may not be fixed and may therefore present a challenge for the limited access cryptocurrency wallet 102 which needs to generate the signed transactions while unfamiliar with the actual commission value (fee) that will apply in the future when the signed transactions are actually transmitted and need to be recorded in the blockchain.

The limited access cryptocurrency wallet 102 may apply one or more methods and/or techniques to overcome this limitation.

In some cryptocurrencies, the commission fee value for recording each transaction in the blockchain may be allocated within the respective transaction itself. For example, in the transaction based cryptocurrencies, the commission value may be typically expressed, by the difference between the input(s) of a transaction and the output(s) of the transaction.

In some exemplary embodiments, the limited access cryptocurrency wallet 102 may predict and/or estimate a plurality of commission fee values that will apply in the future when the signed transactions will be actually transmitted. The limited access cryptocurrency wallet 102 may extend each of the plurality of signed transactions to a set of respective signed transactions each allocating a respective estimated value of cryptocurrency for the commission fee. This means that instead of generating just one signed transaction for each predefined partial value of cryptocurrency transferred to a respective receiving account, the limited access cryptocurrency wallet 102 may generate a set of a plurality of signed transactions for the respective predefined partial value for a plurality of estimated commission values.

When selecting the signed transaction(s) to be transmitted for transferring the required cryptocurrency value to the receiving account, the network connected cryptocurrency wallet 104 may identify a set of signed transactions which include a partial value equal or greater than the value that needs to be transferred and may select one of the signed transactions of the set according to the commission value.

Specifically, the network connected cryptocurrency wallet 104 may select a signed transaction which comprises a commission value that is sufficient, i.e. equals or greater than the commission (fee) currently collected by the computing nodes 204 to record the transaction in the blockchain.

In other exemplary embodiments, the limited access cryptocurrency wallet 102 may generate one or more commission allocation transactions dedicated for transferring commission fees to a cryptocurrency account associated with the network connected cryptocurrency wallet 104 and may transmit the commission allocation transaction(s) to the network connected cryptocurrency wallet 104. The commission allocation transaction(s) may include cryptocurrency that may be used by the network connected cryptocurrency wallet 104 for allocating (paying) the commission (fee) to one or more of the computing nodes 204 (miner) for recording the signed transactions in the blockchain. In real-time, after transmitting one or more signed transactions to transfer cryptocurrency funds from the provisional account to the receiving account, the network connected cryptocurrency wallet 104 may further transmit another transaction for transferring the commission fee from the cryptocurrency account associated with the network connected cryptocurrency wallet 104 to the cryptocurrency account associated with the miner computing node 204. In particular, since the commission fee transaction also needs to be recorded in the blockchain, the commission fee transaction transmitted for transferring cryptocurrency from the cryptocurrency account associated with the network connected cryptocurrency wallet 104 to the cryptocurrency account associated with the miner computing node 204 includes the commission (fee) for recording both the respective signed transaction(s) and the respective commission fee transaction in the blockchain. This technique may be used with miner computing nodes 204 which are smart miners, meaning that they are configured to record one or more first transactions in the blockchain without receiving a commission fee and later receiving a commission fee through a second transaction which may include the commission feed for both the first and second transactions. The network connected cryptocurrency wallet 104 may naturally communicate with the smart miner computing node(s) 204 to inform it that that the commission for recording the signed transaction(s) in the blockchain will be included in a later transaction.

In other exemplary embodiments, the limited access cryptocurrency wallet 102 may establish an agreement with one or more partner computing nodes 204 of the plurality of computing nodes 204. The agreement may state that one or more of the partner computing node(s) 204 will record each of the plurality of signed transactions transmitted by the network connected cryptocurrency wallet 104 to transfer cryptocurrency from one or more of the provisional accounts to respective receiving account(s). The agreement may further define a commission fee that will be delivered to the partner computing node(s) 204, for example, periodically, in advance and/or the like.

It is expected that during the life of a patent maturing from this application many relevant systems, methods and computer programs will be developed and the scope of the terms cryptocurrency service, blockchain and secure channel is intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the embodiments described herein have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the embodiments described herein. To the extent that section headings are used, they should not be construed as necessarily limiting. In addition, any priority document(s) of this application is/are hereby incorporated herein by reference in its/their entirety.

What is claimed is:

1. A method of transferring cryptocurrency from a limited access cryptocurrency wallet, comprising:
using at least one processor of a limited access cryptocurrency wallet having transmit-only network connectivity, the at least one processor is used for:
creating at least one provisional account allocated for at least one recipient;
transmitting at least one transaction to transfer a predefined overall value of cryptocurrency from an account associated with the limited access cryptocurrency wallet to the at least one provisional account, the at least one transaction is recorded in a blockchain maintained by a plurality of networked computing nodes;
generating a plurality of signed transactions for transferring a plurality of predefined partial values of cryptocurrency from the at least one provisional account to at least one receiving account associated with the at least one recipient, a sum of the plurality of predefined partial values does not exceed the predefined overall value;
transmitting the plurality of signed transactions to a network connected cryptocurrency wallet configured to transmit at least one of the plurality of signed transactions for transferring cryptocurrency from the at least one provisional account to the at least one receiving account without physically attending to the limited access cryptocurrency wallet.

2. The method of claim 1, further comprising the limited access cryptocurrency wallet is utilized by a plurality of computing nodes using at least one Multi-Party Computation (MPC) protocol to generate the plurality of signed transactions.

3. The method of claim 1, wherein the plurality of predefined partial values are simultaneously valid.

4. The method of claim 1, further comprising the network connected cryptocurrency wallet is implemented by a subset of the plurality of networked computing nodes using at least one Multi-Party Computation (MPC) protocol to transmit the at least one signed transaction to the at least one receiving account.

5. The method of claim 1, further comprising generating a plurality of signed excess transactions for transferring cryptocurrency from the at least one provisional account to an account associated with the limited access cryptocurrency wallet, the network connected cryptocurrency wallet is configured to transmit at least one of the plurality of signed excess transactions to the account associated with the limited access cryptocurrency wallet in case of an excess in a transaction transmitted to the receiving account.

6. The method of claim 1, further comprising:
creating a plurality of provisional account each allocated to a respective one of a plurality of recipients,
transmitting at least one transaction to transfer a predefined value of cryptocurrency from the account associated with the limited access cryptocurrency wallet to each of the plurality of provisional accounts,
generating a plurality of signed transactions of a plurality of predefined partial values of cryptocurrency from at least one of the plurality of provisional accounts to at least another one of the plurality of provisional accounts.

7. The method of claim 1, wherein the at least one provisional account is created by the limited access cryptocurrency wallet as a payment channel 2-2 multisig account in which each transaction from the at least one provisional account to the at least one receiving account which is recorded in the blockchain is further signed by the at least one recipient, the plurality of signed transactions are defined for transferring predefined gradually increasing partial values of the predefined overall value.

8. The method of claim 7, wherein the network connected cryptocurrency wallet transmits a plurality of the signed transactions for transferring cryptocurrency from the at least one provisional account to the at least one receiving account which are not signed by the at least one recipient and are thus not recorded in the blockchain, each of the plurality of signed transactions replaces a preceding signed transaction transmitted to the at least one receiving account by using a transaction identifier (ID) of the transmitted preceding signed transaction, each transmitted signed transaction includes a value of cryptocurrency which is a sum of cryptocurrency transferred in the preceding signed transaction and a value of cryptocurrency transferred in the respective signed transaction.

9. The method of claim 8, wherein a most recent signed transaction transmitted by the network connected cryptocurrency wallet for transferring cryptocurrency from the at least one provisional account to the at least one receiving account is recorded in the blockchain in case the at least one recipient signs the most recent transmitted signed transaction.

10. The method of claim 9, further comprising the payment channel 2-2 multisig account is a time limited account associated with an expiration time, in case the at least one recipient fails to sign the most recent signed transaction transmitted for transferring cryptocurrency from the at least one provisional account to the at least one receiving account within the expiration time the value of cryptocurrency stored in the payment channel 2-2 multisig account is transmitted back to the account associated with the limited access cryptocurrency wallet.

11. The method of claim 7, further comprising, in case the at least one receiving account is associated with a respective cryptocurrency wallet of the at least one recipient which is not configured to support the payment channel 2-2 multisig account, the payment channel 2-2 multisig account is configured such that each signed transaction transmitted for transferring cryptocurrency from the at least one provisional account to the at least one receiving account which is recorded in the blockchain requires a signature of another network connected device associated with the at least one recipient.

12. The method of claim 7, further comprising the limited access cryptocurrency wallet closes the at least one provisional account by transmitting an instruction to the network connected cryptocurrency wallet to close the payment channel 2-2 multisig account jointly with the at least one recipient.

13. The method of claim 1, wherein the at least one provisional account is created by the limited access cryptocurrency wallet as a new cryptocurrency account associated with the limited access cryptocurrency wallet.

14. The method of claim 13, wherein in case the cryptocurrency is an account based cryptocurrency in which each transaction includes a nonce indicative of a number of previous transactions, the limited access cryptocurrency wallet generates the plurality of signed transactions to constitute a flat distribution of the predefined overall value according to a predefined granularity such that each of the plurality of signed transactions includes a respective one of a plurality of valid nonces and a respective predefined partial value.

15. The method of claim 14, wherein when transferring a certain value of cryptocurrency to the at least one receiving account, the network connected cryptocurrency wallet selects at least one of the plurality of signed transaction having a predefined partial value which is equal or exceeding the certain value, all other signed transaction having the same nonce and other predefined partial value are discarded.

16. The method of claim 14, further comprising generating the plurality of signed transactions for transferring each of the predefined partial values to one of a plurality of receiving accounts by configuring the plurality of signed transactions to constitute a predefined overall value such that each of the plurality of signed transactions includes a respective one of a plurality of valid nonces, the respective predefined partial value of the predefined overall value and a respective target receiving account of the plurality of receiving accounts.

17. The method of claim 16, further comprising defining the account associated with the limited access cryptocurrency wallet as one of the plurality of receiving accounts such that the network connected cryptocurrency wallet transmits at least one of the plurality of signed transactions to transfer cryptocurrency to its associated account.

18. The method of claim 14, further comprising the limited access cryptocurrency wallet closes the at least one provisional account by transmitting an instruction to the network connected cryptocurrency wallet to close the account based provisional account.

19. The method of claim 14, further comprising the limited access cryptocurrency wallet closes the at least one provisional account by transmitting at least one transaction to transfer cryptocurrency to its associated account which is recorded in the blockchain and includes the nonce of at least one of the plurality of signed transactions and a cryptocurrency value of zero.

20. The method of claim 13, wherein in case the cryptocurrency is a transaction based cryptocurrency (UTXO) in which each transaction includes at least one input value of cryptocurrency which is traced to a respective output value of a previous transaction, the limited access cryptocurrency wallet generates the plurality of signed transactions to constitute a hierarchical Directed Acyclic Graph (DAG) comprising the plurality of signed transaction such that each signed transaction is derived from a higher layer signed transaction and includes a Transaction ID (TXID), the hierarchical DAG is constructed to distribute the predefined overall value according to a predefined granularity.

21. The method of claim 20, wherein the DAG is constructed as a hierarchical tree.

22. The method of claim 20, wherein, when transferring a certain value of cryptocurrency to the at least one receiving account, the network connected cryptocurrency wallet selects at least a segment of the hierarchical DAG comprising at least one signed transaction having a predefined partial value which is equal or exceeding the certain value, each signed transaction of the segment which is not transmitted is marked as unusable.

23. The method of claim 22, further comprising informing the limited access cryptocurrency wallet of a remaining value of cryptocurrency available in at least one unusable transaction by inserting at least one limited length string to the limited access cryptocurrency wallet via a limited capacity input interface of the limited access cryptocurrency wallet configured to receive at least one limited length string.

24. The method of claim 23, further comprising the at least one string includes an index of the at least one unusable transaction such that limited access cryptocurrency wallet derives the remaining value from the index which is known to the limited access cryptocurrency wallet which initially generated the plurality of signed transactions including the of at least one unusable transaction.

25. The method of claim 23, further comprising the limited access cryptocurrency wallet transmits a transaction to its associated account which is recorded in the blockchain and comprises the cumulative sum of cryptocurrency partial values included in the at least one unusable signed transaction.

26. The method of claim 20, further comprising in case the at least one recipient uses another limited access cryptocurrency wallet, the other limited access cryptocurrency wallet is informed of the value of cryptocurrency transferred to its associated receiving account by inserting at least one limited length string to the other limited access cryptocurrency wallet via a limited capacity input interface of the other limited access cryptocurrency wallet, the at least one string comprising a description of a first signed transaction of the plurality of signed transactions transmitted to the receiving account of the other limited access cryptocurrency wallet, a structure of the hierarchical DAG and an index of a final signed transaction of the plurality of signed transactions transmitted to transfer cryptocurrency to the receiving account of the other limited access cryptocurrency wallet.

27. The method of claim 1, further comprising, in case a commission needs to be allocated to at least one of the plurality of computing nodes for recording the at least one signed transaction in the blockchain, the limited access cryptocurrency wallet extends each of the plurality of signed transactions to a set of respective signed transactions each allocating a respective value of cryptocurrency for the commission, the network connected cryptocurrency wallet selects one of the transactions of the set according to the commission value.

28. The method of claim 1, further comprising, in case a commission needs to be allocated to at least one of the plurality of computing nodes for recording the at least one signed transaction in the blockchain, the limited access cryptocurrency wallet generates at least one commission allocation transaction comprising a cryptocurrency value dedicated for commission fees and transmits the at least one commission allocation transaction to transfer cryptocurrency to an account associated with the network connected cryptocurrency wallet, the network connected cryptocurrency wallet transmits at least one commission allocation transaction to transfer cryptocurrency to the at least one computing node which recorded the at least one signed transaction, the at least one commission allocation transaction comprising a value of cryptocurrency sufficient for commission for both the at least one signed transaction and for the at least one commission allocation transaction.

29. The method of claim 1, further comprising, in case a commission needs to be allocated to at least one of the plurality of computing nodes for recording the at least one signed transaction in the blockchain, the limited access cryptocurrency wallet establishes an agreement with at least partner computing node of the plurality of computing nodes stating that the at least partner computing node records each of the plurality of signed transactions transmitted by the network connected cryptocurrency wallet to transfer cryptocurrency from the at least one provisional account to the at least one receiving account.

30. A limited access cryptocurrency wallet device, comprising:
a non-transitory storage medium storing a code; and
at least one processor coupled to the non-transitory storage medium, the at least one processor executes the code, the code comprising:
code instructions to create at least one provisional account allocated for at least one recipient;
code instructions to transmit at least one transaction to transfer a predefined overall value of cryptocurrency from an account associated with the limited access cryptocurrency wallet to the at least one provisional account, the at least one transaction is recorded in a blockchain maintained by a plurality of networked computing nodes;
code instructions to generate a plurality of signed transactions for transferring a plurality of predefined partial values of cryptocurrency from the at least one provisional account to at least one receiving account associated with the at least one recipient, a sum of the plurality of predefined partial values does not exceed the predefined overall value;
code instructions to transmit the plurality of signed transactions to a network connected cryptocurrency wallet configured to transmit at least one of the plurality of signed transactions for transferring cryptocurrency from the at least one provisional account to the at least one receiving account without physically attending to the limited access cryptocurrency wallet.
